(19) United States
(12) Patent Application Publication
(10) Pub. No.: US 2026/0205013 A1
(43) Pub. Date: Jul. 16, 2026

(54) CONTROLLER CIRCUIT AND DC/DC CONVERTER USING SAME

(71) Applicant: ROHM CO., LTD., Kyoto (JP)

(72) Inventor: Shun FUKUSHIMA, Kyoto (JP)

(21) Appl. No.: 19/443,383

(22) Filed: Jan. 8, 2026

(30) Foreign Application Priority Data
Jan. 15, 2025 (JP) 2025-005787

(51) Int. Cl. H02M 3/158; H02M 1/00

(52) U.S. Cl. CPC H02M 3/158; H02M 1/0032

(57) ABSTRACT

A controller circuit of a DC/DC converter, which generates an output voltage according to an input voltage, includes: a pulse width modulation (PWM) comparator configured to compare a periodic ramp voltage with a comparison voltage; and a voltage supply circuit configured to supply an initial voltage of the comparison voltage to the PWM comparator, wherein the initial voltage is a voltage corresponding to a ratio between the input voltage and the output voltage.

### CROSS REFERENCE TO RELATED APPLICATION

The present invention claims priority under 35 U.S.C. § 119 to Japanese Patent Application No. 2025-005787, filed on Jan. 15, 2025, the entire contents of which are incorporated herein by reference.

### TECHNICAL FIELD

The present disclosure relates to a controller circuit and a DC/DC converter using the same.

### BACKGROUND

In the related art, DC/DC converters that generate an output voltage corresponding to an input voltage by switching transistors are known.

FIG. 13 is a circuit diagram of a conventional DC/DC converter 9. The conventional DC/DC converter 9 steps down an input voltage V_{IN9} to generate an output voltage V_{OUT9}. As shown in FIG. 13, the conventional DC/DC converter 9 includes an error amplifier 90, an oscillator 92, a pulse width modulation (PWM) comparator 94, a NAND gate 96, an AND gate 98, switches SW91 to SW93, a high-side transistor MH9, a low-side transistor ML9, resistors R₉₁ to R₉₃, and capacitors C₉₁ and C₉₂.

The switch SW91 is provided between an output terminal of the error amplifier 90 and a non-inverting input terminal of the PWM comparator 94. A first end of the resistor R₉₃ is connected to the non-inverting input terminal of the PWM comparator 94, and a second end of the resistor R₉₃ is connected to a first end of the capacitor C₉₂. The switch SW92 is provided between the first end of the capacitor C₉₂ and the ground. The switch SW93 connects a first end of the capacitor C₉₁ to an application terminal of the output voltage V_{OUT9} and the first end of the capacitor C₉₂. Second ends of the capacitors C₉₁ and C₉₂ are connected to the ground.

The conventional DC/DC converter 9 can transition to a sleep mode under light load, in which both the high-side transistor MH9 and the low-side transistor ML9 are turned off and stopped and both the error amplifier 90 and the PWM comparator 94 are in a sleep state. Transitioning to the sleep mode and releasing the sleep mode are controlled by a sleep signal S_{SLP9}.

In the sleep mode, the sleep signal S_{SLP9} is at a low level, and the switch SW91 is turned off. In addition, the switch SW92 is turned on, and the capacitor C₉₂ is biased at 0 V. Further, the switch SW93 connects the first end of the capacitor C₉₁ to the application terminal of the output voltage V_{OUT9}, and the capacitor C₉₁ is biased by the output voltage V_{OUT9}.

When the sleep mode is released, the sleep signal S_{SLP9} is at a high level, the switch SW91 is turned on, and the switch SW92 is turned off. In addition, the switch SW93 connects the first end of the capacitor C₉₁ to the first end of the capacitor C₉₂.

The error amplifier 90 generates a comparison voltage V_{C9} corresponding to a difference between a feedback voltage V_{FB9}, which is obtained by dividing the output voltage V_{OUT9} by the resistors R₉₁ and R₉₂, and a reference voltage V_{REF9}. The PWM comparator 94 compares the comparison voltage V_{C9} with a periodic ramp voltage V_{RAMP9}, which is generated by the oscillator 92, to generate a comparison signal S_{CMP9}. The NAND gate 96 generates a high-side gate signal S_{GH9} in response to the comparison signal S_{CMP9}, and the AND gate 98 generates a low-side gate signal S_{GL9} in response to the comparison signal S_{CMP9}. The high-side transistor MH9 switches in response to the high-side gate signal S_{GH9}, and the low-side transistor ML9 switches in response to the low-side gate signal S_{GL9}, thereby generating the output voltage V_{OUT9}.

When the DC/DC converter 9 transitions to the sleep mode, the sleep signal S_{SLP9} changes from a high level to a low level, causing the error amplifier 90 and the PWM comparator 94 to enter the sleep state. Further, both the high-side transistor MH9 and the low-side transistor ML9 are turned off and stopped.

FIG. 14 is a timing chart illustrating an operation of the conventional DC/DC converter 9 when the sleep mode is released. The DC/DC converter 9 is in the sleep mode before timing t₉₁, and the sleep mode is released at timing t₉₁.

When the sleep mode is released, the switch SW92 is turned off, and the switch SW93 connects the first end of the capacitor C₉₁ to the first end of the capacitor C₉₂. As a result, the comparison voltage V_{C9} at the non-inverting input terminal of the PWM comparator 94 becomes a voltage expressed by the following Equation (1):

$${V}_{C 9} = {k}_{9} \times {V}_{OUT 9} = \{ {C}_{91} / ( {C}_{91} + {C}_{92} ) \} \times {V}_{OUT 9} , \qquad Equation ( 1 )$$

$$where {k}_{9} = {C}_{91} / ( {C}_{91} + {C}_{92} ) .$$

where k₉=C₉₁/(C₉₁+C₉₂).

The PWM comparator 94 sets the comparison voltage V_{C9} expressed by Equation (1) as an initial voltage, and generates the comparison signal S_{CMP9} in response to the ramp voltage V_{RAMP9}. An amplitude voltage of the ramp voltage V_{RAMP9} is proportional to the input voltage V_{IN9} and is expressed as k₉×V_{IN9}. In response to the generation of the comparison signal S_{CMP9}, the switching of the high-side transistor MH9 and the low-side transistor ML9 resumes. At this time, by appropriately adjusting k₉, a desired duty ratio (=V_{OUT9}/V_{IN9}) can be achieved when releasing the sleep mode.

### BRIEF DESCRIPTION OF DRAWINGS

The accompanying drawings, which are incorporated in and constitute a part of the specification, illustrate embodiments of the present disclosure.

FIG. 1 is a block diagram of a DC/DC converter according to a first embodiment.

FIG. 2 is a block diagram of a resistive voltage divider according to the first embodiment.

FIG. 3 is a timing chart showing an exemplary operation of a controller circuit according to the first embodiment.

FIG. 4 is a timing chart showing an exemplary operation of the resistive voltage divider according to the first embodiment.

FIG. 5 is a block diagram of a DC/DC converter according to a second embodiment.

FIG. 6 is a block diagram of a voltage supply circuit according to a third embodiment.

FIG. 7 is a block diagram of a resistive voltage divider according to the third embodiment.

FIG. 8 is a circuit diagram of a resistor circuit according to the third embodiment.

FIG. 9 is a block diagram of a DC/DC converter according to a fourth embodiment.

FIG. 10 is a block diagram of a resistive voltage divider according to the fourth embodiment.

FIG. 11 is a timing chart showing an exemplary operation of the DC/DC converter according to the fourth embodiment in a step-down mode.

FIG. 12 is a timing chart showing an exemplary operation of the DC/DC converter according to the fourth embodiment in a step-up mode.

FIG. 13 is a conventional circuit diagram of a DC/DC converter.

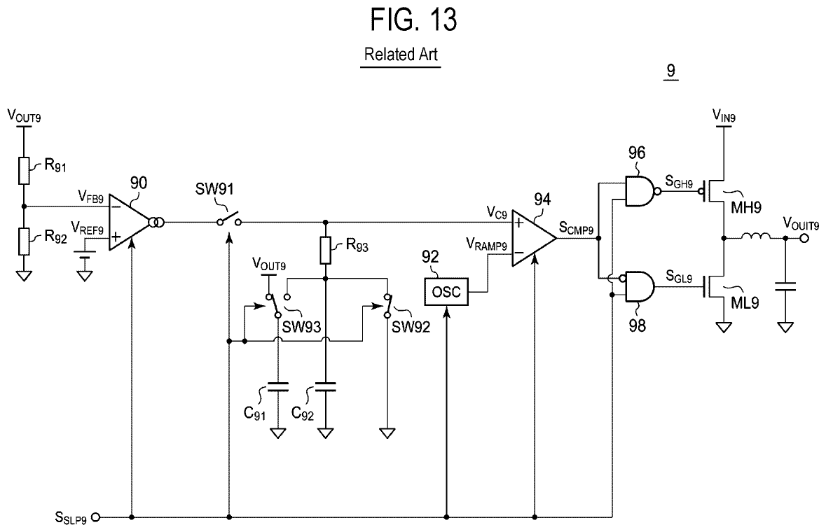

FIG. 14 is a timing chart illustrating an operation of the conventional DC/DC converter when a sleep mode is released.

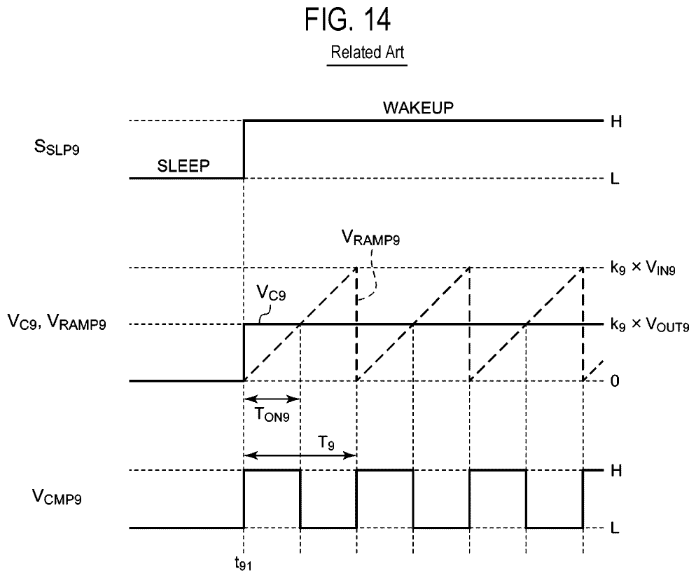

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### Overview

An overview of some exemplary embodiments of the present disclosure will be described. This overview presents, in a simplified form, some concepts of one or more embodiments, as a prologue to the detailed description which will be presented later, and for the purpose of basic understanding of the embodiments, but it is not intended to limit the scope of the invention or the disclosure. This overview is not a comprehensive overview of all possible embodiments, and it is intended to neither identify key elements of all embodiments nor delineate the scope of some or all aspects. For the sake of convenience, “an embodiment” may be used to refer to one embodiment (example or modification) or a plurality of embodiments (examples or modifications).

A controller circuit according to one embodiment is a controller circuit of a DC/DC converter that generates an output voltage according to an input voltage. The controller circuit includes: a PWM comparator configured to compare a periodic ramp voltage with a comparison voltage; and a voltage supply circuit configured to supply an initial voltage of the comparison voltage to the PWM comparator. The initial voltage is a voltage corresponding to a ratio between the input voltage and the output voltage.

With this configuration, the initial voltage corresponds to the ratio between the input voltage and the output voltage. Thus, the PWM comparator can generate a signal that achieves a desired duty cycle without changing an amplitude voltage of the ramp voltage. Therefore, it is not necessary to reduce the amplitude voltage of the ramp voltage, and it is possible to suppress the duty cycle from being affected by fluctuations in the comparison voltage of the PWM comparator. As a result, disturbance of the output voltage when releasing a sleep mode can be suppressed.

In one embodiment, the voltage supply circuit may include: an input voltage dividing circuit configured to divide the input voltage to generate the comparison voltage and an adjustment voltage; an output voltage dividing circuit configured to divide the output voltage to generate a bias voltage; a comparator configured to compare an amplitude voltage of the ramp voltage with the comparison voltage generated by the input voltage dividing circuit; and a voltage division adjusting circuit configured to adjust a voltage division ratio of each of the input voltage dividing circuit and the output voltage dividing circuit. The voltage division adjusting circuit may adjust the voltage division ratio of the input voltage dividing circuit based on a comparison result of the comparator so that the adjustment voltage approaches the amplitude voltage, and adjust the voltage division ratio of the output voltage dividing circuit to generate the bias voltage by dividing the output voltage with a voltage division ratio of the adjustment voltage after the adjustment in the input voltage dividing circuit.

In one embodiment, the comparison voltage generated by the input voltage dividing circuit may be a first comparison voltage, and the input voltage dividing circuit may further generate a second comparison voltage smaller than the first comparison voltage. The comparator may be a first comparator, and the voltage supply circuit may further include a second comparator configured to compare the second comparison voltage with the amplitude voltage. The voltage division adjusting circuit may adjust the voltage division ratio of the input voltage dividing circuit based on a first comparison result of the first comparator and a second comparison result of the second comparator so that the amplitude voltage becomes a voltage between the first comparison voltage and the second comparison voltage, and adjust the voltage division ratio of the output voltage dividing circuit to generate the bias voltage by dividing the output voltage with a voltage division ratio between a voltage division ratio of the first comparison voltage after adjustment in the input voltage dividing circuit and a voltage division ratio of the second comparison voltage after adjustment in the input voltage dividing circuit.

In one embodiment, the input voltage dividing circuit may include a first voltage dividing resistor, a second voltage dividing resistor, a third voltage dividing resistor, and a fourth voltage dividing resistor, which are connected in series. One end of the first voltage dividing resistor opposite to the second voltage dividing resistor may be connected to an application terminal of the input voltage. One end of the fourth voltage dividing resistor opposite to the third voltage dividing resistor may be connected to a ground. The first comparison voltage may be a voltage between the first voltage dividing resistor and the second voltage dividing resistor. The second comparison voltage may be a voltage between the third voltage dividing resistor and the fourth voltage dividing resistor. The adjustment voltage may be a voltage between the second voltage dividing resistor and the third voltage dividing resistor. At least one of the first voltage dividing resistor or the fourth voltage dividing resistor may be a variable resistor. The voltage division adjusting circuit may adjust the voltage division ratio of the input voltage dividing circuit by adjusting a resistance value of each of the first voltage dividing resistor and the fourth voltage dividing resistor, and adjust the voltage division ratio of the output voltage dividing circuit to generate the bias voltage by dividing the output voltage with the voltage division ratio of the adjustment voltage after the adjustment in the input voltage dividing circuit.

In one embodiment, the voltage division adjusting circuit may sequentially change the voltage division ratio of the input voltage dividing circuit based on the first comparison result and the second comparison result. When the first comparison result indicates that the amplitude voltage is greater than the first comparison voltage, the voltage division adjusting circuit may increase the first comparison voltage and the second comparison voltage while performing down-counting or up-counting. When the second comparison result indicates that the second comparison voltage is greater than the amplitude voltage, the voltage division adjusting circuit may decrease the first comparison voltage and the second comparison voltage while performing counting opposite to that when the first comparison result indicates that the amplitude voltage is greater than the first comparison voltage. The voltage division adjusting circuit may adjust the voltage division ratio of the output voltage dividing circuit based on the counting result.

In one embodiment, the voltage division adjusting circuit may complete the adjustment of the voltage division ratio of the input voltage dividing circuit when the first comparison result of the first comparator indicates that the amplitude voltage is smaller than the first comparison voltage and the second comparison result of the second comparator indicates that the second comparison voltage is smaller than the amplitude voltage.

In one embodiment, the fourth voltage dividing resistor may be a variable resistor. The voltage division adjusting circuit may adjust the voltage division ratio of the input voltage dividing circuit by switching the resistance value of the fourth voltage dividing resistor.

In one embodiment, the voltage supply circuit may further include: a capacitor provided between an output node of the output voltage dividing circuit and an input terminal of the PWM comparator; and a switch connected in parallel with the capacitor.

In one embodiment, the voltage supply circuit may supply the bias voltage as the initial voltage via the switch when the switch is turned on.

In one embodiment, the voltage supply circuit may be further configured such that when the PWM comparator is in a sleep state, a voltage at the output node of the output voltage dividing circuit is a ground voltage and the switch is turned on, and when the PWM comparator switches from the sleep state to a wake-up state, the switch is turned off and a bias voltage generated by adjusting the voltage division ratio of the output voltage dividing circuit is supplied as the initial voltage via capacitive coupling of the capacitor.

In one embodiment, the voltage supply circuit may further include: a buffer circuit provided to buffer the bias voltage generated by the output voltage dividing circuit; and a resistor circuit provided between an output terminal of the buffer circuit and an input terminal of the PWM comparator.

In one embodiment, the voltage supply circuit may further include: a capacitor provided between the output terminal of the buffer circuit and the resistor circuit or between the resistor circuit and the input terminal of the PWM comparator; and a switch connected in parallel with the capacitor.

In one embodiment, the resistor circuit may be configured as a variable resistor.

In one embodiment, the voltage supply circuit may further include: a buffer circuit provided to buffer the bias voltage generated by the output voltage dividing circuit; and a resistor circuit provided between an output terminal of the buffer circuit and an input terminal of the PWM comparator. The resistor circuit may include: a first resistor path configured as first and second resistors connected in series; and a second resistor path configured as third and fourth resistors connected in series. The first resistor path may be connected in parallel to the second resistor path. A ratio between a combined resistance of the first voltage dividing resistor and the second voltage dividing resistor and a combined resistance of the third voltage dividing resistor and the fourth voltage dividing resistor may be the same as a ratio between a combined resistance of the first resistor and the second resistor and a combined resistance of the third resistor and the fourth resistor.

In one embodiment, the DC/DC converter may be of a step-up/down type. The PWM comparator may be a first PWM comparator, and the controller circuit may further include a second PWM comparator. The first PWM comparator may compare the ramp voltage as a first ramp voltage with the comparison voltage. The second PWM comparator may compare a second ramp voltage, which is obtained by inverting the first ramp voltage, with the comparison voltage, which is common to the first PWM comparator. The voltage supply circuit may supply the initial voltage of the comparison voltage to each of the first PWM comparator and the second PWM comparator.

In one embodiment, the voltage supply circuit may include: an input voltage dividing circuit configured to divide the input voltage to generate an input comparison voltage and a first adjustment voltage; an output voltage dividing circuit configured to divide the output voltage to generate an output comparison voltage and a second adjustment voltage; a comparator; and a voltage division adjusting circuit configured to adjust a voltage division ratio of each of the input voltage dividing circuit and the output voltage dividing circuit. The comparator may compare the input comparison voltage or the output comparison voltage with a common amplitude voltage of the first ramp voltage and the second ramp voltage. The voltage division adjusting circuit may be further configured to, based on a comparison result of the comparator: when the input voltage is greater than the output voltage, adjust the voltage division ratio of the input voltage dividing circuit so that the first adjustment voltage approaches the amplitude voltage, and adjust the voltage division ratio of the output voltage dividing circuit so that the second adjustment voltage becomes a voltage obtained by dividing the output voltage with a voltage division ratio of the first adjustment voltage after the adjustment in the input voltage dividing circuit; and when the output voltage is greater than the input voltage, adjust the voltage division ratio of the output voltage dividing circuit so that the second adjustment voltage approaches the amplitude voltage, and adjust the voltage division ratio of the input voltage dividing circuit so that the first adjustment voltage becomes a voltage obtained by dividing the input voltage with a voltage division ratio of the second adjustment voltage after the adjustment in the output voltage dividing circuit.

In one embodiment, the voltage supply circuit may be further configured to supply, when the output voltage is greater than the input voltage, a voltage, which is obtained by adding half the amplitude voltage to a differential voltage obtained by subtracting the adjusted second adjustment voltage from the adjusted first adjustment voltage, as the initial voltage.

A DC/DC converter according to one embodiment may include the above-described controller circuit.

### Embodiments

Hereinafter, embodiments will now be described with reference to the drawings. Like or equivalent components, members, and processes illustrated in each drawing are given like reference numerals and a repeated description thereof will be properly omitted. Further, the embodiments are presented by way of example only and are not intended to limit the present disclosure and invention, and any features or combination thereof described in the embodiments may not necessarily be essential to the present disclosure and invention.

In the present disclosure, “a state where a member A is connected to a member B” includes not only a case where the member A and the member B are physically and directly connected, but also a case where the member A and the member B are indirectly connected via any other member that does not substantially affect an electrical connection state between the members A and B or does not impair functions and effects achieved by combinations of the members A and B.

Similarly, “a state where a member C is disposed (provided) between a member A and a member B” includes not only a case where the member A and the member C or the member B and the member C are directly connected, but also a case where the member A and the member C or the member B and the member C are indirectly connected via any other member that does not substantially affect an electrical connection state between the members A and C or the members B and C or does not impair functions and effects achieved by combinations of the members A and C or the members B and C.

Further, in the present disclosure, symbols attached to electrical signals such as voltage signals and current signals, or circuit elements such as resistors, capacitors, and inductors, represent respective voltage values, current values, or circuit constants (resistance, capacitance, and inductance) as necessary.

Further, in the present disclosure, “integrated” includes a case where all of the components of a circuit are formed on a semiconductor substrate and a case where main components of a circuit are integrated, and some resistors, capacitors, and the like may be provided outside the semiconductor substrate for adjusting circuit constants.

### First Embodiment

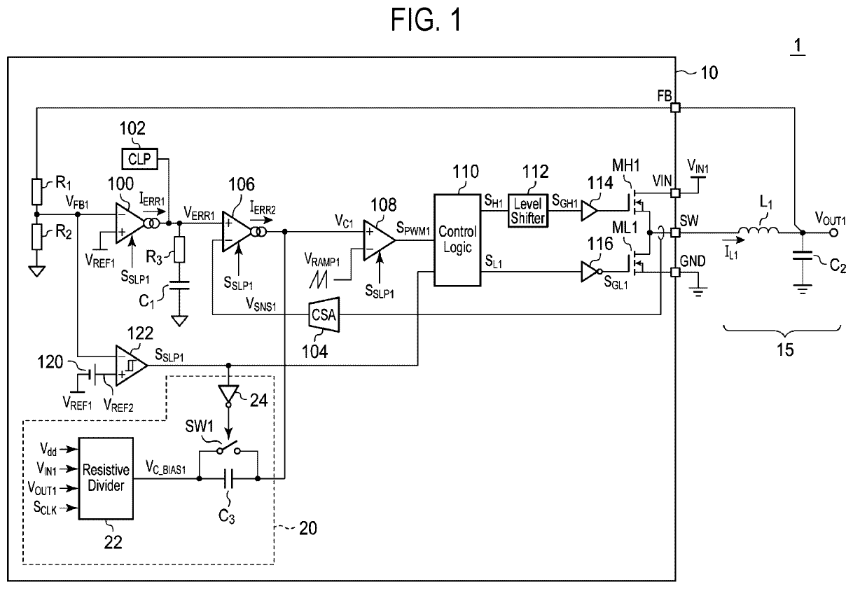

FIG. 1 is a block diagram of a DC/DC converter 1 according to a first embodiment. The DC/DC converter 1 according to the first embodiment is of a step-down type, and generates an output voltage V_{OUT1} by stepping down an input voltage V_{IN1}. The DC/DC converter 1 includes a controller circuit 10 and a peripheral circuit 15.

The controller circuit 10 is a circuit for controlling an operation of the DC/DC converter 1. The controller circuit 10 according to the present embodiment includes a voltage supply circuit 20, a first error amplifier 100, a clamp circuit 102, a current sense amplifier 104, a second error amplifier 106, a PWM comparator 108, a logic circuit 110, a level shifter 112, a buffer circuit 114, a NOT gate 116, a voltage source 120, a sleep comparator 122, a high-side transistor MH1, a low-side transistor ML1, resistors R₁ to R₃, a capacitor C₁, a feedback pin FB, an input pin VIN, a switching pin SW, and a ground pin GND.

The controller circuit 10 may be integrated on a single semiconductor chip. In addition, some components of the controller circuit 10 may be externally attached to the semiconductor chip. For example, the high-side transistor MH1 and the low-side transistor ML1 may be externally attached to the semiconductor chip.

The peripheral circuit 15 includes an inductor L₁ and a capacitor C₂. A first end of the inductor L₁ is connected to the switching pin SW, and a second end of the inductor L₁ is connected to a first end of the capacitor C₂. The first end of the capacitor C₂ is connected to the feedback pin FB, and the second end of the capacitor C₂ is grounded. The output voltage V_{OUT1} is generated at the first end of the capacitor C₂. The input voltage V_{IN1} is applied to the input pin VIN, and the ground pin GND is grounded.

The controller circuit 10 according to the present embodiment is configured to be capable of switching between a sleep mode and a wake-up mode. The sleep mode is a mode in which at least the PWM comparator 108 is in a sleep state, more specifically, a mode in which each of the first error amplifier 100, the second error amplifier 106, and the PWM comparator 108 is in a sleep state and each of the high-side transistor MH1 and the low-side transistor ML1 is turned off and stopped. The wake-up mode is a mode in which at least the PWM comparator 108 is in an operation state, more specifically, a mode in which each of the first error amplifier 100, the second error amplifier 106, and the PWM comparator 108 is in an operation state and each of the high-side transistor MH1 and the low-side transistor ML1 is switching.

The resistors R₁ and R₂ are connected in series and divide the output voltage V_{OUT1}. A first end of the resistor R₁ is connected to the feedback pin FB, and a second end of the resistor R₁ is connected to a first end of the resistor R₂. A second end of the resistor R₂ is connected to the ground. A feedback voltage V_{FB1} generated by dividing the output voltage V_{OUT1} is input to an inverting input terminal of the first error amplifier 100 and an inverting input terminal of the sleep comparator 122. The feedback voltage V_{FB1} is expressed by the following equation:

$${V}_{FB 1} = {V}_{OUT 1} \times {R}_{2} / ( {R}_{1} + {R}_{2} ) .$$

The first error amplifier 100 may be configured as a transconductance amplifier. The first error amplifier 100 generates a first error current I_{ERR1} corresponding to a difference between a reference voltage V_{REF1} input to a non-inverting input terminal thereof and the feedback voltage V_{FB1} input to an inverting input terminal thereof. The clamp circuit 102 clamps a voltage at an output terminal of the first error amplifier 100.

A first end of the resistor R₃ is connected to the output terminal of the first error amplifier 100, and a second end of the resistor R₃ is connected to a first end of the capacitor C₁. A second end of the capacitor C₁ is connected to the ground. An error voltage V_{ERR1} generated in response to the first error current I_{ERR1} is input to a non-inverting input terminal of the second error amplifier 106. The current sense amplifier 104 detects an output current I_{L1} flowing through the inductor L₁ and generates a sense voltage V_{SNS1}. The sense voltage V_{SNS1} is input to an inverting input terminal of the second error amplifier 106.

The second error amplifier 106 generates a second error current I_{ERR2} corresponding to a difference between the error voltage V_{ERR1} and the sense voltage V_{SNS1}. In the wake-up mode, a comparison voltage V_{C1} corresponding to the second error current I_{ERR2} is generated. More specifically, the comparison voltage V_{C1} is generated by sinking the second error current I_{ERR2} from a capacitor C₃ of the voltage supply circuit 20 to be described later or sourcing the second error current I_{ERR2} to the capacitor C₃.

The PWM comparator 108 compares a periodic ramp voltage V_{RAMP1} input to an inverting input terminal thereof with the comparison voltage V_{C1} input to a non-inverting input terminal thereof to generate a PWM signal S_{PWM1}. In the present embodiment, an amplitude voltage of the ramp voltage V_{RAMP1} has a fixed magnitude that is independent of the input voltage V_{IN1}.

The logic circuit 110 generates a high-side control signal S_{H1} and a low-side control signal S_{L1} in response to the PWM signal S_{PWM1}. The level shifter 112 shifts a level of the high-side control signal S_{H1} to generate a high-side gate signal S_{GH1}. The NOT gate inverts the low-side gate signal S_{L}1 to generate a low-side gate signal S_{GL1}.

Each of the high-side transistor MH1 and the low-side transistor ML1 is configured as a metal oxide semiconductor (MOS) transistor, and in the present embodiment, both are of an N-channel type. A drain of the high-side transistor MH1 is connected to the input pin VIN, and a source of the high-side transistor MH1 is connected to the switching pin SW. A drain of the low-side transistor ML1 is connected to the switching pin SW, and a source of the low-side transistor ML1 is connected to the ground pin GND. Operations of the high-side transistor MH1 are controlled by the high-side gate signal S_{GH1} input via the buffer circuit 114, and operations of the low-side transistor ML1 are controlled by the low-side gate signal S_{GL1}.

The sleep comparator 122 may be configured, for example, as a hysteresis comparator and a window comparator. The sleep comparator 122 compares the feedback voltage V_{FB1} input to an inverting input terminal thereof with a reference voltage V_{REF2} (>V_{REF1}) input to a non-inverting input terminal thereof to generate a sleep signal S_{SLP1}. The reference voltage V_{REF2} is a voltage obtained by adding a voltage generated by the voltage source 120 to the reference voltage V_{REF1}. The sleep signal S_{SLP1} becomes a low level when the feedback voltage V_{FB1} floats under light load.

The sleep signal S_{SLP1} is input to the voltage supply circuit 20, the first error amplifier 100, the second error amplifier 106, the PWM comparator 108, and the logic circuit 110. When the sleep signal S_{SLP1} is at a low level, the controller circuit 10 enters the sleep mode. When the sleep signal S_{SLP1} is at a high level, the controller circuit 10 enters the wake-up mode.

The voltage supply circuit 20 is a circuit that supplies an initial voltage of the comparison voltage V_{C1} to the PWM comparator 108. Here, the initial voltage is a voltage provided as an initial value of the comparison voltage V_{C1} when the controller circuit 10 switches from the sleep mode to the wake-up mode. The initial voltage is a voltage that corresponds to a ratio (V_{OUT1}/V_{IN1}) between the input voltage V_{IN1} to the output voltage V_{OUT1}.

The voltage supply circuit 20 according to the present embodiment includes a resistive voltage divider 22, a NOT gate 24, a switch SW1, and a capacitor C₃. The capacitor C₃ is provided between an output terminal of the resistive voltage divider 22 (more specifically, an output node of a second voltage dividing circuit to be described later) and a non-inverting input terminal of the PWM comparator 108. The switch SW1 is provided in parallel with the capacitor C₃. The NOT gate 24 controls an on/off state of the switch SW1 in response to the sleep signal S_{SLP1}. Specifically, the NOT gate 24 turns the switch SW1 off when the sleep signal S_{SLP1} is at a high level, and turns the switch SW1 on when the sleep signal S_{SLP1} is at a low level.

The resistive voltage divider 22 generates a bias voltage V_{C_BIAS1} in response to a power supply voltage V_{dd}, the input voltage V_{IN1}, the output voltage V_{OUT1}, and a clock signal S_{CLK}. In the present embodiment, during the sleep mode, the bias voltage V_{C_BIAS1} is supplied as the initial voltage of the comparison voltage V_{C1} to the non-inverting input terminal of the PWM comparator 108 via the switch SW1.

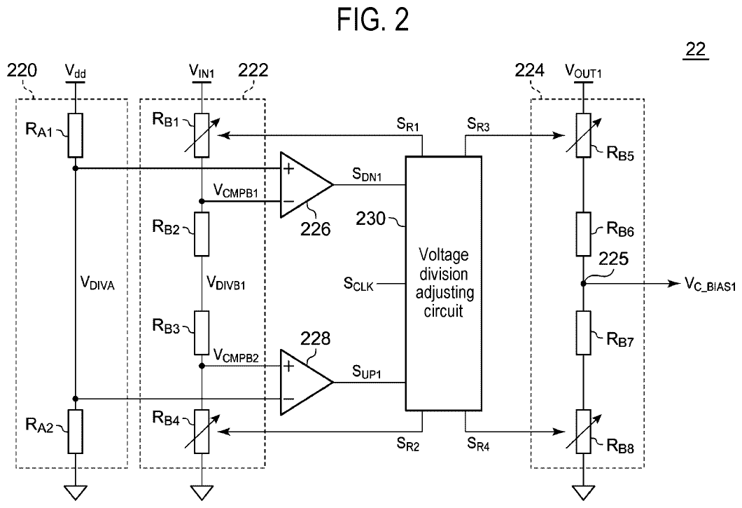

FIG. 2 is a block diagram of the resistive voltage divider 22 according to the present embodiment. As shown in FIG. 2, the resistive voltage divider 22 includes a power supply voltage dividing circuit 220, an input voltage dividing circuit 222, an output voltage dividing circuit 224, a first comparator 226, a second comparator 228, and a voltage division adjusting circuit 230.

The power supply voltage dividing circuit 220 divides the power supply voltage V_{dd} to generate a target voltage V_{DIVA} having the same magnitude as the amplitude voltage of the ramp voltage V_{RAMP1}. The target voltage V_{DIVA} is input to a non-inverting input terminal of the first comparator 226 and a non-inverting input terminal of the second comparator 228. The power supply voltage dividing circuit 220 according to the present embodiment includes two voltage dividing resistors R_{A1} and R_{A2}. A first end of the voltage dividing resistor R_{A1} is connected to an application terminal of the power supply voltage V_{dd}, and a second end of the voltage dividing resistor R_{A1} is connected to a first end of the voltage dividing resistor R_{A2}. A second end of the voltage dividing resistor R_{A2} is connected to the ground. The target voltage V_{DIVA} is generated between the voltage dividing resistors R_{A1} and R_{A2}, as expressed by the following equation: V_{DIVA}=V_{dd}×R_{A2}/(R_{A1}+R_{A2}).

The input voltage dividing circuit 222 divides the input voltage V_{IN1} to generate a first comparison voltage V_{CMPB1}, a second comparison voltage V_{CMPB2}, and an adjustment voltage V_{DIVB1}. The second comparison voltage V_{CMPB2} is a voltage smaller than the first comparison voltage V_{CMPB1}. The first comparison voltage V_{CMPB1} is input to an inverting input terminal of the first comparator 226, and the second comparison voltage V_{CMPB2} is input to an inverting input terminal of the second comparator 228.

The input voltage dividing circuit 222 according to the present embodiment includes a first voltage dividing resistor R_{B1}, a second voltage dividing resistor R_{B2}, a third voltage dividing resistor R_{B3}, and a fourth voltage dividing resistor R_{B4}, which are connected in series. Each of the first voltage dividing resistor R_{B1} and the fourth voltage dividing resistor R_{B4} is a variable resistor. A resistance value of the first voltage dividing resistor R_{B1} is adjusted by a resistance signal S_{R1}, and a resistance value of the fourth voltage dividing resistor R_{B4} is adjusted by a resistance signal S_{R2}.

A first end of the first voltage dividing resistor R_{B1} opposite to the second voltage dividing resistor R_{B2} is connected to an application terminal of the input voltage V_{IN1}, and a second end of the first voltage dividing resistor R_{B1} is connected to a first end of the second voltage dividing resistor R_{B2}. A second end of the second voltage dividing resistor R_{B2} is connected to a first end of the third voltage dividing resistor R_{B3}. A first end of the fourth voltage dividing resistor R_{B4} opposite to the third voltage dividing resistor R_{B3} is connected to the ground, and a second end of the fourth voltage dividing resistor R_{B4} is connected to a second end of the third voltage dividing resistor R_{B3}.

The second and third voltage dividing resistors R_{B2} and R_{B3} provide hysteresis to a counting operation, which will be described later, in the voltage division adjusting circuit 230. By providing the second and third voltage dividing resistors R_{B2} and R_{B3}, it is possible to more reliably converge a process of adjusting a voltage division ratio of the input voltage dividing circuit 222 than when the second and third voltage dividing resistors R_{B2} and R_{B3} are not provided (i.e., when the first and fourth voltage dividing resistors R_{B1} and R_{B4} are short-circuited).

The first comparison voltage V_{CMPB1} is a voltage generated between the first and second voltage dividing resistors R_{B1} and R_{B2}, as expressed by the following equation: V_{CMPB1}=V_{IN1}×(R_{B2}+R_{B3}+R_{B4})/(R_{B1}+R_{B2}+R_{B3}+R_{B4}).

The second comparison voltage V_{CMPB2} is a voltage generated between the third and fourth voltage dividing resistors R_{B3} and R_{B4}, as expressed by the following equation: V_{CMPB2}=V_{IN1}×R_{B4}/(R_{B1}+R_{B2}+R_{B3}+R_{B4}).

The adjustment voltage V_{DIVB1} is a voltage generated between the second and third voltage dividing resistors R_{B2} and R_{B3}, as expressed by the following equation: V_{DIVB1}=V_{IN1}×(R_{B3}+R_{B4})/(R_{B1}+R_{B2}+R_{B3}+R_{B4}). Therefore, a magnitude relationship between the first comparison voltage V_{CMPB1}, the second comparison voltage V_{CMPB2}, and the adjustment voltage V_{DIVB1} is V_{CMPB2}<V_{DIVB1}<V_{CMPB1}.

The first comparator 226 compares the first comparison voltage V_{CMPB1} with the amplitude voltage of the ramp voltage V_{RAMP1}. The first comparator 226 according to the present embodiment compares the first comparison voltage V_{CMPB1} with the target voltage V_{DIVA} to generate a down-signal S_{DN1} according to the comparison result (first comparison result). The down-signal S_{DN1} becomes a high level when the target voltage V_{DIVA} is greater than the first comparison voltage V_{CMPB1}, and becomes a low level when the target voltage V_{DIVA} is less than the first comparison voltage V_{CMPB1}.

The second comparator 228 compares the second comparison voltage V_{CMPB2} with the amplitude voltage of the ramp voltage V_{RAMP1}. The second comparator 228 according to the present embodiment compares the second comparison voltage V_{CMPB2} with the target voltage V_{DIVA} to generate an up-signal S_{UP1} according to the comparison result (second comparison result). The up-signal S_{UP1} becomes a high level when the second comparison voltage V_{CMPB2} is greater than the target voltage V_{DIVA}, and becomes a low level when the second comparison voltage V_{CMPB2} is less than the target voltage V_{DIVA}.

The output voltage dividing circuit 224 divides the output voltage V_{OUT1} to generate the bias voltage V_{C_BIAS1}. The output voltage dividing circuit 224 according to the present embodiment includes a fifth voltage dividing resistor R_{B5}, a sixth voltage dividing resistor R_{B6}, a seventh voltage dividing resistor R_{B7}, and an eighth voltage dividing resistor R_{B8}, which are connected in series. Each of the fifth voltage dividing resistor R_{B5} and the eighth voltage dividing resistor R_{B8} is a variable resistor. A resistance value of the fifth voltage dividing resistor R_{B5} is adjusted by a resistance signal S_{R3}, and a resistance value of the eighth voltage dividing resistor R_{B8} is adjusted by a resistance signal S_{R4}. In the present embodiment, the sixth voltage dividing resistor R_{B6} has the same resistance value as the second voltage dividing resistor R_{B2}, and the seventh voltage dividing resistor R_{B7} has the same resistance value as the third voltage dividing resistor R_{B3}.

In the present embodiment, the fifth voltage dividing resistor R_{B5}, the sixth voltage dividing resistor R_{B6}, the seventh voltage dividing resistor R_{B7}, and the eighth voltage dividing resistor R_{B8} are connected in the same manner as the first voltage dividing resistor R_{B1}, the second voltage dividing resistor R_{B2}, the third voltage dividing resistor R_{B3}, and the fourth voltage dividing resistor R_{B4}. However, a first end of the fifth voltage dividing resistor R_{B5} opposite to the sixth voltage dividing resistor R_{B6} is connected to an application terminal of the output voltage V_{OUT1}. The bias voltage V_{C_BIAS1} is a voltage generated between the sixth and seventh voltage dividing resistors R_{B6} and R_{B7} (at an output node 225), as expressed by the following equation: V_{C_BIAS1}=V_{OUT1}×(R_{B7}+R_{B8})/(R_{B5}+R_{B6}+R_{B7}+R_{B8}).

The voltage division adjusting circuit 230 adjusts voltage division ratios of the input voltage dividing circuit 222 and the output voltage dividing circuit 224. The voltage division adjusting circuit 230 according to this embodiment generates the resistance signals S_{R1} to S_{R4} in response to the clock signal S_{CLK}, the down signal S_{DN1}, and the up signal S_{UP1}, and adjusts the resistance values of the first voltage dividing resistor R_{B1}, the fourth voltage dividing resistor R_{B4}, the fifth voltage dividing resistor R_{B5}, and the eighth voltage dividing resistor R_{B8}.

The voltage division adjusting circuit 230 according to the present embodiment adjusts the voltage division ratio of the input voltage dividing circuit 222 based on the down-signal S_{DN1} and the up-signal S_{UP1} so that the adjustment voltage V_{DIVB1} approaches the amplitude voltage. Specifically, the voltage division adjusting circuit 230 adjusts the voltage division ratio of the input voltage dividing circuit 222 by adjusting the resistance values of the first voltage dividing resistor R_{B1} and the fourth voltage dividing resistor R_{B4}.

The voltage division adjusting circuit 230 according to the present embodiment sequentially changes the voltage division ratio of the input voltage dividing circuit 222 based on the down-signal S_{DN1} and the up-signal S_{UP1}. The voltage division adjusting circuit 230 according to the present embodiment includes a counter (not shown) that performs down-counting or up-counting, for example, at each rising edge of the clock signal S_{CLK}, according to levels of the down-signal S_{DN1} and the up-signal S_{UP1}.

The voltage division adjusting circuit 230 according to the present embodiment performs down-counting at each rising edge of the clock S_{CLK} when the down-signal S_{DN1} is at a high level (when the down-signal S_{DN1} indicates that the target voltage V_{DIVA} is greater than the first comparison voltage V_{CMPB1}). In this case, the voltage division adjusting circuit 230 increases the first comparison voltage V_{CMPB1} and the second comparison voltage V_{CMPB2}. For example, the voltage division adjusting circuit 230 may output the resistance signals S_{R1} and S_{R2} indicating a count value, decrease the first voltage dividing resistor R_{B1}, and increase the fourth voltage dividing resistor R_{B4}.

Conversely, when the up-signal S_{UP1} is at a high level (when the up-signal S_{UP1} indicates that the second comparison voltage V_{CMPB2} is greater than the target voltage V_{DIVA}), the voltage division adjusting circuit 230 according to the present embodiment performs up-counting at each rising edge of the clock S_{CLK}. In this case, the voltage division adjusting circuit 230 decreases the first comparison voltage V_{CMPB1} and the second comparison voltage V_{CMPB2}. For example, the voltage division adjusting circuit 230 may output the resistance signals S_{R1} and S_{R2} indicating the count value, increase the first voltage dividing resistor R_{B1}, and decrease the fourth voltage dividing resistor R_{B4}.

In addition, in the present embodiment, an example is described in which the voltage division adjusting circuit 230 performs down-counting when the down-signal S_{DN1} is at a high level and performs up-counting when the up-signal S_{UP1} is at a high level, but the present disclosure is not limited thereto. For example, the voltage division adjusting circuit 230 may perform up-counting when the down-signal S_{DN1} is at a high level and perform down-counting when the up-signal S_{UP1} is at a high level. As described above, when the up-signal S_{UP1} is at a high level, the voltage division adjusting circuit 230 performs counting opposite to that when the down-signal S_{DN1} is at a high level.

The voltage division adjusting circuit 230 according to the present embodiment completes the adjustment of the voltage division ratio of the input voltage dividing circuit 222 when the down-signal S_{DN1} indicates that the target voltage V_{DIVA} is smaller than the first comparison voltage V_{CMPB1} and the up-signal S_{UP1} indicates that the second comparison voltage V_{CMPB2} is smaller than the target voltage V_{DIVA}. Specifically, the voltage division adjusting circuit 230 completes the adjustment of the voltage division ratio of the input voltage dividing circuit 222 when both the down-signal S_{DN1} and the up-signal S_{UP1} are at a low level.

The voltage division adjusting circuit 230 adjusts the voltage division ratio of the input voltage dividing circuit 222 and adjusts the voltage division ratio of the output voltage dividing circuit 224 to generate the bias voltage V_{C_BIAS1} by dividing the output voltage V_{OUT1} with a voltage division ratio between a voltage division ratio of the first comparison voltage V_{CMPB1} and a voltage division ratio of the second comparison voltage V_{CMPB2} after the adjustment in the input voltage dividing circuit 222. Specifically, the voltage division adjusting circuit 230 adjusts the resistance values of the fifth voltage dividing resistor R_{B5} and the eighth voltage dividing resistor R_{B8} so as to meet the following equation: R_{B4}/(R_{B1}+R_{B2}+R_{B3}+R_{B4})<(R_{B7}+R_{B8})/(R_{B5}+R_{B6}+R_{B7}+R_{B8})<(R_{B2}+R_{B3}+R_{B4})/(R_{B1}+R_{B2}+R_{B3}+R_{B4}).

The voltage division adjusting circuit 230 according to the present embodiment adjusts the voltage division ratio of the output voltage dividing circuit 224 based on the first comparison result of the first comparator 226 and the second comparison result of the second comparator 228 to generate the bias voltage V_{C_BIAS1} by dividing the output voltage V_{OUT1} with the voltage division ratio of the adjusted adjustment voltage V_{DIVB1}. Specifically, the voltage division adjusting circuit 230 adjusts the resistance values of the fifth voltage dividing resistor R_{B5} and the eighth voltage dividing resistor R_{B8} to meet the following equation:

$$( {R}_{B 3} + {R}_{B 4} ) / ( {R}_{B 1} + {R}_{B 2} + {R}_{B 3} + {R}_{B 4} ) = ( {R}_{B 7} + {R}_{B 8} ) / ( {R}_{B 5} + {R}_{B 6} + {R}_{B 7} + {R}_{B 8} ) .$$

More specifically, the voltage division adjusting circuit 230 adjusts the voltage division ratio of the output voltage dividing circuit 224 by matching the resistance value of the fifth voltage dividing resistor R_{B5} to the resistance value of the first voltage dividing resistor R_{B1} and matching the resistance value of the eighth voltage dividing resistor R_{B8} to the resistance value of the fourth voltage dividing resistor R_{B4}. The voltage division adjusting circuit 230 may adjust the voltage division ratio of the output voltage dividing circuit based on a count result according to the down-signal S_{DN1} and the up-signal S_{UP1}.

Ideally, when the adjustment of the voltage division ratio of the input voltage dividing circuit 222 is completed, the adjustment voltage V_{DIVB1} becomes equal to the target voltage V_{DIVA}. In this case, the voltage division ratio of the output voltage dividing circuit 224 is adjusted so that the bias voltage V_{C_BIAS1} is equal to the target voltage V_{DIVA}×V_{OUT1}/V_{IN1}. Therefore, ideally, the bias voltage V_{C_BIAS1} is expressed as follows: V_{C_BIAS1}=(k_{A}×V_{dd}×V_{OUT1})/V_{IN1}, where k_{A}=R_{A2}/(R_{A1}+R_{A2}).

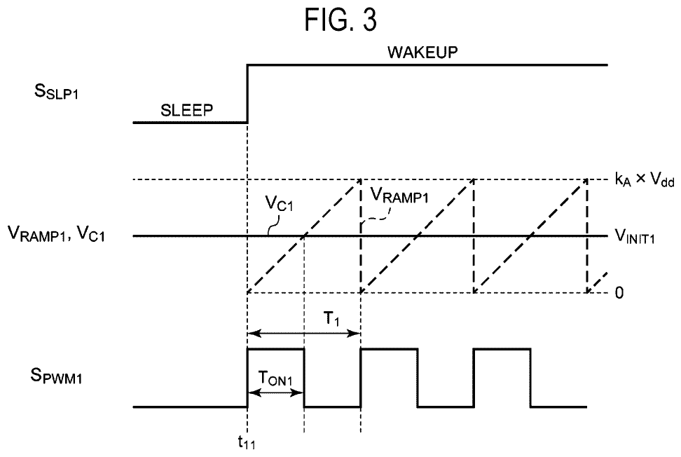

FIG. 3 is a timing chart showing an example of an operation of the controller circuit 10 according to the present embodiment. Before timing t₁₁, the controller circuit 10 is in the sleep mode, and the sleep signal S_{SLP1} is at a low level. In the sleep mode, the switch SW1 is turned on, and the resistive voltage divider 22 generates the bias voltage V_{C_BIAS1}. Here, it is assumed that an ideal bias voltage V_{C_BIAS1} is generated. The bias voltage V_{C_BIAS1} is supplied as the initial value V_{INIT1} of the comparison voltage V_{C1} to the non-inverting input terminal of the PWM comparator 108 via the switch SW1.

At timing t₁₁, the sleep signal S_{SLP1} switches to a high level, and the controller circuit 10 enters the wake-up mode. In response to this, the switch SW1 is turned off, and the first error amplifier 100, the second error amplifier 106, and the PWM comparator 108 are released from the sleep states and start operating. In addition, each of the high-side transistor MH1 and the low-side transistor ML1 begins switching in response to the PWM signal S_{PWM1} which corresponds to the comparison result between the comparison voltage V_{C1} and the ramp voltage V_{RAMP1}.

While bottoms of the comparison voltage V_{C1} and the ramp voltage V_{RAMP1} are 0 V in FIG. 3, the bottoms may be greater than 0 V. However, a magnitude of the bottom is the same for the comparison voltage V_{C1} and the ramp voltage V_{RAMP1}.

The PWM comparator 108 generates the PWM signal S_{PWM1} by using the bias voltage V_{C_BIAS1} as the initial voltage V_{INIT1} of the comparison voltage V_{C1}. After timing t₁₁, the comparison voltage V_{C1} is adjusted by the second error current I_{ERR2} generated by the second error amplifier 106, and a duty (T_{ON1}/T₁) of the PWM signal S_{PWM1} is modulated. Minute fluctuations in the comparison voltage V_{C1} are omitted in FIG. 3.

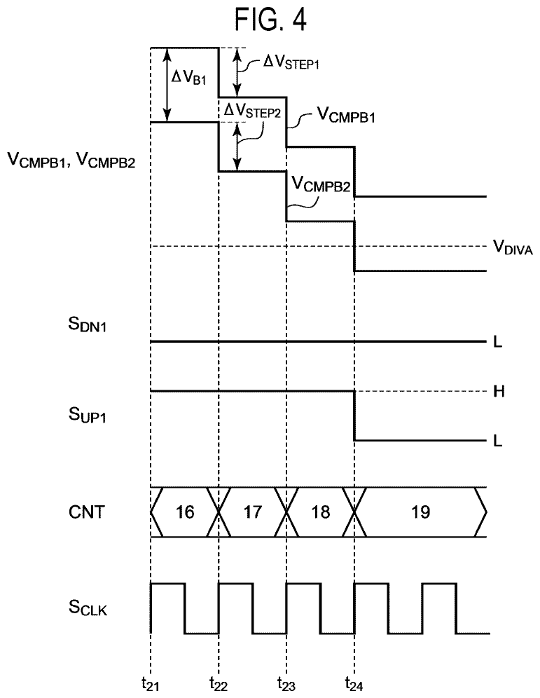

FIG. 4 is a timing chart showing an example of the operation of the resistive voltage divider 22 according to the present embodiment. At timing t₂₁, it is assumed that the resistive voltage divider 22 starts a process of generating the bias voltage V_{C_BIAS1}. At timing t₂₁, the voltage division ratio of the input voltage dividing circuit 222 is initialized to a predetermined voltage division ratio. The initial value of a count value CNT may be approximately half a maximum output value of a counter. For example, in the case of a 5-bit counter that counts from 0 to 31, the initial value of the count value CNT may be 16, as shown in FIG. 4.

A differential voltage ΔV_{B1} shown in FIG. 4 is a difference between the first comparison voltage V_{CMPB1} and the second comparison voltage V_{CMPB2}, and is expressed by the following equation: ΔV_{B1}=V_{CMPB1}−V_{CMPB2}=V_{IN1}×(R_{B2}+R_{B3})/(R_{B1}+R_{B2}+R_{B3}+R_{B4}).

At the initial voltage division ratio, both the first comparison voltage V_{CMPB1} and the second comparison voltage V_{CMPB}2 are greater than the target voltage V_{DIVA}. Therefore, the down-signal S_{DN1} is at a low level and the up-signal S_{UP1} is at a high level. In response to this, at timing t₂₂, the counter performs up-counting, and the count value CNT increases from 16 to 17. Further, the voltage division ratio of the input voltage dividing circuit 222 is changed so that the first comparison voltage V_{CMPB1} decreases by a step voltage ΔV_{STEP1} and the second comparison voltage V_{CMPB2} decreases by a step voltage ΔV_{STEP2}.

When the voltage division ratio of the input voltage dividing circuit 222 is changed, magnitudes of the step voltages ΔV_{STEP1} and ΔV_{STEP2} may be smaller than the differential voltage Δ_{VB1}. In this case, the voltage division ratio of the input voltage dividing circuit 222 can converge more reliably to an appropriate value.

Subsequently, at timings t₂₃ and t₂₄, the count value CNT is changed in response to the down-signal S_{DN1} and the up-signal S_{UP1}, and increases from 17 to 18 and from 18 to 19, respectively. At timings t₂₃ and t₂₄, the voltage division ratio of the input voltage dividing circuit 222 is also changed. In this operation example, at timing t₂₄, both the down-signal S_{DN1} and the up-signal S_{UP1} become a low level. In response to this, the adjustment of the voltage division ratio of the input voltage dividing circuit 222 is completed. Further, based on this held count result, the voltage division ratio of the output voltage dividing circuit 224 is adjusted to generate the bias voltage V_{C_BIAS1}.

The configuration and operation example of the DC/DC converter 1 and the controller circuit 10 thereof according to the present embodiment have been described above. The controller circuit 10 according to the present embodiment includes the PWM comparator 108 that compares the periodic ramp voltage V_{RAMP1} with the comparison voltage V_{C1}, and the voltage supply circuit 20 that supplies the initial voltage V_{INIT1} of the comparison voltage V_{C1} to the PWM comparator 108. The initial voltage V_{INIT1} is a voltage that corresponds to the ratio between the input voltage V_{IN1} and the output voltage V_{OUT1}.

With this configuration, the initial voltage V_{INIT1} has a magnitude corresponding to the duty ratio, and therefore, unlike in the related art, it is not necessary to make the amplitude voltage of the ramp voltage V_{RAMP1} proportional to the input voltage V_{IN1}. Therefore, even when the input voltage V_{IN1} decreases, the amplitude voltage of the ramp voltage V_{RAMP1} remains unchanged, which suppresses the duty cycle from being affected by fluctuations in the comparison voltage V_{C1}. As a result, disturbance of the output voltage V_{OUT1} when releasing the sleep mode is suppressed.

### Second Embodiment

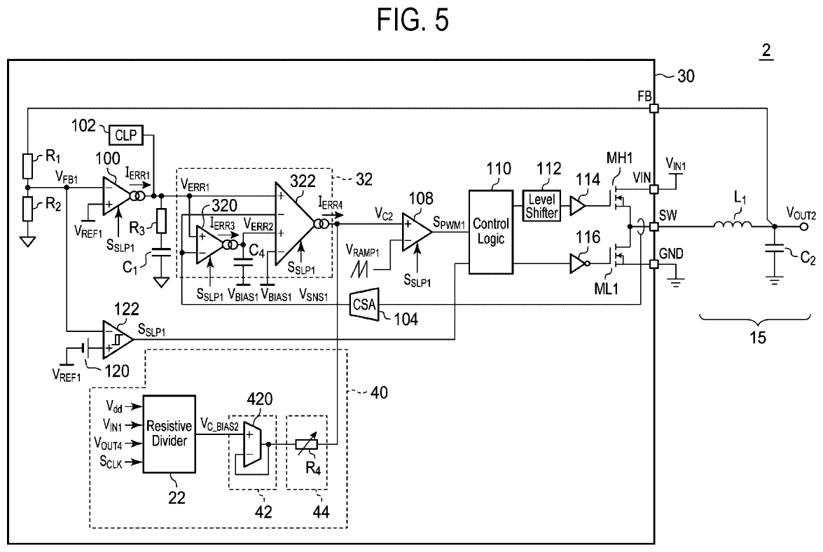

FIG. 5 is a block diagram of a DC/DC converter 2 according to a second embodiment. The DC/DC converter 2 generates an output voltage V_{OUT2} by stepping down an input voltage V_{IN1}. The DC/DC converter 2 according to the present embodiment includes a controller circuit 30 and the peripheral circuit 15. The controller circuit 30 according to the present embodiment is different from the controller circuit 10 according to the first embodiment mainly in that the former includes an error amplifier circuit 32 instead of the second error amplifier 106, and a configuration of a voltage supply circuit 40 is different from that of the voltage supply circuit 20 according to the first embodiment.

The error amplifier circuit 32 includes a second error amplifier 320, a third error amplifier 322, and a capacitor C₄. Each of the second error amplifier 320 and the third error amplifier 322 enters a sleep state when a sleep signal S_{SLP1} is at a low level, and enters an operation state when the sleep signal S_{SLP1} is at a high level.

The second error amplifier 320 generates a third error current I_{ERR3} corresponding to a difference between a sense voltage V_{SNS1} input to an inverting input terminal thereof and an error voltage V_{ERR1} input to a non-inverting input terminal thereof. A first end of the capacitor C₄ is connected to an output terminal of the second error amplifier 320, and a second end of the capacitor C₄ is connected to an application terminal of a bias voltage V_{BIAS1}. As the third error current I_{ERR3} is sourced to or sunk from the first end of the capacitor C₄, the difference between the sense voltage V_{SNS1} and the error voltage V_{ERR1} is integrated in the capacitor C₄, and an error voltage V_{ERR2} is generated at the first end of the capacitor C₄.

The third error amplifier 322 is configured as a transconductance amplifier having two inverting input terminals and two non-inverting input terminals. The third error amplifier 322 is configured so that the sense voltage V_{SNS1} is input to a first inverting input terminal thereof, the bias voltage V_{BIAS1} is input to a second inverting input terminal thereof, the error voltage V_{ERR1} is input to a first non-inverting input terminal thereof, and the error voltage V_{ERR2} is input to a second non-inverting input terminal thereof.

The third error amplifier 322 generates a fourth error current I_{ERR4} corresponding to a difference between a voltage input to the two inverting input terminals thereof and a voltage input to the two non-inverting input terminals thereof, i.e., (V_{ERR1}+V_{ERR2})−(V_{SNS1}+V_{BIAS1}). In a wake-up mode, a comparison voltage V_{C2} corresponding to the fourth error current I_{ERR4} is generated. More specifically, the comparison voltage V_{C2} is generated by causing the fourth error current I_{ERR4} to flow through a resistor R₄ of the voltage supply circuit 40 which will be described below.

The voltage supply circuit 40 according to the second embodiment includes the resistive voltage divider 22, a buffer circuit 42, and a resistor circuit 44.

The buffer circuit 42 is configured to buffer a bias voltage V_{C_BIAS2} generated by the resistive voltage divider 22 (specifically, the output voltage dividing circuit 224). The buffer circuit 42 according to the present embodiment includes an operational amplifier 420 that forms a voltage follower. An inverting input terminal of the operational amplifier 420 is connected to an output terminal of the operational amplifier 420, and a non-inverting input terminal of the operational amplifier 420 is connected to the output terminal of the resistive voltage divider 22 (more specifically, the output node 225 of the output voltage dividing circuit 224).

The resistor circuit 44 according to the present embodiment is provided between an output terminal of the buffer circuit 42 and the non-inverting input terminal of the PWM comparator 108. The resistor circuit 44 according to the present embodiment is configured as a single resistor R₄. The resistor R₄ is a variable resistor, and a first end of the resistor R₄ is connected to the output terminal of the operational amplifier 420, and a second end of the resistor R₄ is connected to the non-inverting input terminal of the PWM comparator 108.

When the controller circuit 30 is in a sleep mode, each of the first error amplifier 100, the second error amplifier 320, the third error amplifier 322, and the PWM comparator 108 enters a sleep state. At this time, the capacitor C₄ is short-circuited by using a switch (not shown) or the like, and the output terminal of the second error amplifier 320 is discharged. Further, the bias voltage V_{C_BIAS2} generated by the resistive voltage divider 22 is supplied as the initial voltage of the bias voltage V_{C2} to the non-inverting input terminal of the PWM comparator 108 via the buffer circuit 42 and the resistor R₄.

When the controller circuit 30 switches from the sleep mode to the wake-up mode, the sleep states of the first error amplifier 100, the second error amplifier 320, the third error amplifier 322, and the PWM comparator 108 are released. At this time, when there is no difference between the error voltage V_{ERR1} and the sense voltage V_{SNS1}, the bias voltage V_{C2} is maintained at V_{C_BIAS2}. As a result, each of the high-side transistor MH1 and the low-side transistor ML1 switches at an appropriate duty cycle corresponding to the input voltage V_{IN1} and the output voltage V_{OUT2}.

The configuration of the DC/DC converter 2 and the controller circuit 30 thereof according to the second embodiment has been described above.

The resistive voltage divider 22 according to the first embodiment is a resistor for phase compensation as viewed from the second error amplifier 106, and the combined resistance thereof is an important parameter in determining characteristics of the DC/DC converter 1. However, the combined resistance of the resistive voltage divider 22 fluctuates and thus, may have an inappropriate value in some cases.

The voltage supply circuit 40 according to the second embodiment is provided with the buffer circuit 42. Thus, current capacity at the output terminal of the operational amplifier 420 is high, and an arbitrary current can be sunk or sourced. A resistor for phase compensation as viewed from the third error amplifier 322 does not include the resistive voltage divider 22, but mainly includes the resistor R₄. Therefore, by adjusting a resistance value of the resistor R₄ to an appropriate value, an appropriate resistor for phase compensation can be implemented regardless of a change in the combined resistance of the resistive voltage divider 22.

Further, in the related art described above, although the resistance value of the resistor R₉₃ is fixed, the amplitude voltage of the ramp voltage V_{RAMP9} is proportional to the input voltage V_{IN9}. Therefore, as the input voltage V_{IN9} increases, a change in the duty cycle in response to a change in the comparison voltage V_{C9} is suppressed.

In contrast to the related art, the amplitude voltage of the ramp voltage V_{RAMP1} according to the second embodiment is fixed. Therefore, the resistance value of the resistor R₄ is adjusted according to the input voltage V_{IN1} (or the voltage division ratio of the resistive voltage divider 22). Specifically, by decreasing the resistance value of the resistor R₄ as the input voltage V_{IN1} increases, or more specifically, by making the resistance value of the resistor R₄ inversely proportional to the input voltage V_{IN1}, it is possible to obtain a gain equivalent to that of the related art.

### Third Embodiment

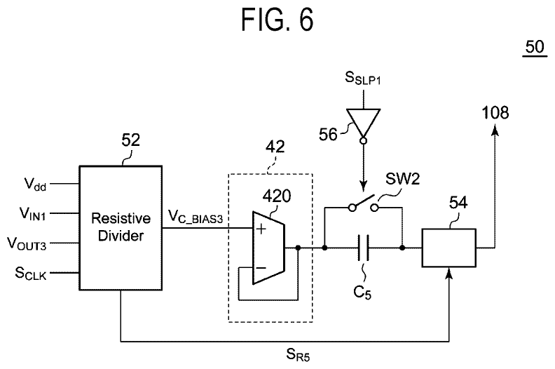

FIG. 6 is a block diagram of a voltage supply circuit 50 according to a third embodiment. The voltage supply circuit 50 according to the third embodiment may be provided in the controller circuit 10, for example, in place of the voltage supply circuit 20 according to the first embodiment.

The voltage supply circuit 50 according to the third embodiment includes a resistive voltage divider 52, the buffer circuit 42, a resistor circuit 54, a NOT gate 56, a switch SW2, and a capacitor C₅.

The capacitor C₅ is provided between the output terminal of the buffer circuit 42 and the resistor circuit 54. Specifically, a first end of the capacitor C₅ is connected to the output terminal of the operational amplifier 420, and a second end of the capacitor C₅ is connected to the resistor circuit 54. In the wake-up mode, the capacitor C₅ functions to integrate a difference between the error voltage V_{ERR1} and the sense voltage V_{SNS1}. Further, the capacitor C₅ may be provided between the resistor circuit 54 and the non-inverting input terminal of the PWM comparator 108.

The switch SW2 is connected in parallel to the capacitor C₅. An on/off state of the switch SW2 is controlled by the NOT gate 56. For example, when the sleep signal S_{SLP1} is at a high level, the switch SW2 is turned off, and when the sleep signal S_{SLP1} is at a low level, the switch SW2 is turned on.

The resistor circuit 54 is provided between the second end of the capacitor C₅ and the non-inverting input terminal of the PWM comparator 108. The resistor circuit 54 according to the present embodiment includes a plurality of resistors and is configured so that a combined resistance thereof can be adjusted. The combined resistance of the resistor circuit 54 is adjusted by a resistance signal S_{R5} from the resistive voltage divider 52. Further, in the wake-up mode, the second error current I_{ERR2} flows through the resistor circuit 54, and a comparison voltage of the PWM comparator 108 is generated according to the second error current I_{ERR2}.

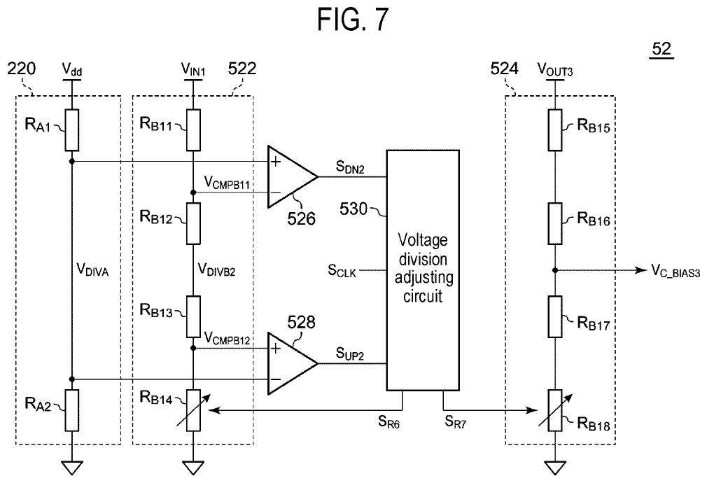

FIG. 7 is a block diagram of the resistive voltage divider 52 according to the third embodiment. The resistive voltage divider 52 according to the present embodiment includes the power supply voltage dividing circuit 220, an input voltage dividing circuit 522, an output voltage dividing circuit 524, a first comparator 526, a second comparator 528, and a voltage division adjusting circuit 530.

The input voltage dividing circuit 522 divides the input voltage V_{IN1} to generate a first comparison voltage V_{CMPB11}, a second comparison voltage V_{CMPB12}, and an adjustment voltage V_{DIVB2}. The input voltage dividing circuit 522 includes a first voltage dividing resistor R_{B11}, a second voltage dividing resistor R_{B12}, a third voltage dividing resistor R_{B13}, and a fourth voltage dividing resistor R_{B14}. The first voltage dividing resistor R_{B11}, the second voltage dividing resistor R_{B12}, the third voltage dividing resistor R_{B13}, and the fourth voltage dividing resistor R_{B14} are connected in the same manner as the first voltage dividing resistor R_{B1}, the second voltage dividing resistor R_{B2}, the third voltage dividing resistor R_{B3}, and the fourth voltage dividing resistor R_{B4} according to the first embodiment. In the present embodiment, the first voltage dividing resistor R_{B11} is not a variable resistor, and only the fourth voltage dividing resistor R_{B14} is a variable resistor. A resistance value of the fourth voltage dividing resistor R_{B14} is adjusted by a resistance signal S_{R6}.

The output voltage dividing circuit 524 divides an output voltage V_{OUT3} to generate a bias voltage V_{C_BIAS3}. The output voltage dividing circuit 524 includes a fifth voltage dividing resistor R_{B15}, a sixth voltage dividing resistor R_{B16}, a seventh voltage dividing resistor R_{B17}, and an eighth voltage dividing resistor R_{B18}. The fifth voltage dividing resistor R_{B15}, the sixth voltage dividing resistor R_{B16}, the seventh voltage dividing resistor R_{B17}, and the eighth voltage dividing resistor R_{B18} are connected in the same manner as the fifth voltage dividing resistor R_{B5}, the sixth voltage dividing resistor R_{B6}, the seventh voltage dividing resistor R_{B7}, and the eighth voltage dividing resistor R_{B8} according to the first embodiment. In the present embodiment, the fifth voltage dividing resistor R_{B15} is not a variable resistor, and only the eighth voltage dividing resistor R_{B18} is a variable resistor. A resistance value of the eighth voltage dividing resistor R_{B18} is adjusted by a resistance signal S_{R7}.

The first comparator 526 compares the first comparison voltage V_{CMPB11} with the target voltage V_{DIVA} and generates a down-signal S_{DN2}. The second comparator 528 compares the second comparison voltage V_{CMPB12} with the target voltage V_{DIVA} and generates an up-signal S_{UP2}.

The voltage division adjusting circuit 530 adjusts a voltage division ratio of the input voltage dividing circuit 522 by switching the resistance value of the fourth voltage dividing resistor R_{B14}, and adjusts a voltage division ratio of the output voltage dividing circuit 524 by switching the resistance value of the eighth voltage dividing resistor R_{B18}. The voltage division adjusting circuit 530 according to the present embodiment adjusts the voltage division ratios of the input voltage dividing circuit 522 and the output voltage dividing circuit 524 based on the down-signal S_{DN2} and the up-signal S_{UP2}. A method of adjusting the voltage division ratios by the voltage division adjusting circuit 530 is the same as the method of adjusting the voltage division ratios by the voltage division adjusting circuit 230 according to the first embodiment, except that the resistance values of the first voltage dividing resistor R_{B11} and the fifth voltage dividing resistor R_{B15} are not adjusted.

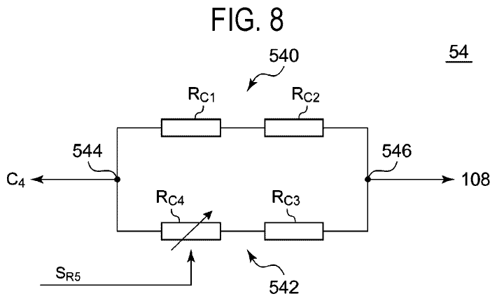

FIG. 8 is a circuit diagram of the resistor circuit 54 according to the third embodiment. The resistor circuit 54 according to the present embodiment includes a first resistor path 540 and a second resistor path 542.

The first resistor path 540 is configured as a first resistor R_{C1} and a second resistor R_{C2}, which are connected in series. The second resistor path 542 is configured as a third resistor R_{C3} and a fourth resistor R_{C4}, which are connected in series. The first resistor path 540 is connected in parallel to the second resistor path 542. Each of an end of the first resistor R_{C1} opposite to the second resistor R_{C2} and an end of the fourth resistor R_{C4} opposite to the third resistor R_{C3} is connected to a first node 544 connected to the capacitor C₄. Each of an end of the second resistor R_{C2} opposite to the first resistor R_{C1} and an end of the third resistor R_{C3} opposite to the fourth resistor R_{C4} is connected to a second node 546 connected to the non-inverting input terminal of the PWM comparator 108.

A combined resistance R_{C} of the resistor circuit 54 is expressed by the following equation: R_{C}=(R_{C1}+R_{C2})×(R_{C3}+R_{C4})/(R_{C1}+R_{C2}+R_{C3}+R_{C4}).

The fourth resistor R_{C4} is a variable resistor. In the present embodiment, a resistance value of the fourth resistor R_{C4} is adjusted after the voltage division ratio of the resistive voltage divider 52 is adjusted. Specifically, the resistance value of the fourth resistor R_{C4} is adjusted so that a ratio of a combined resistance of the first voltage dividing resistor R_{B11} and the second voltage dividing resistor R_{B12} to a combined resistance of the third voltage dividing resistor R_{B13} and the fourth voltage dividing resistor R_{B14} is the same as a ratio of a combined resistance of the first resistor R_{C1} and the second resistor R_{C2} to a combined resistance of the third resistor R_{C3} and the fourth resistor R_{C4}. In other words, the resistance value of the fourth resistor R_{C4} is adjusted to meet the following equation: (R_{B11}+R_{B12})/(R_{B13}+R_{B14})=(R_{C1}+R_{C2})/(R_{C3}+R_{C4}).

When a voltage division ratio of the adjustment voltage V_{DIVB2} in the input voltage dividing circuit 522 is k_{B2}(=(R_{B13}+R_{B14})/(R_{B11}+R_{B12}+R_{B13}+R_{B14})), the adjustment voltage V_{DIVB2} is expressed as V_{DIVB2}=k_{B2}×V_{IN1}. Ideally, the voltage division ratio of the input voltage dividing circuit 522 is adjusted so that the adjustment voltage V_{DIVB2} matches the target voltage V_{DIVA}. In this case, k_{B2} is expressed by the following equation: k_{B2}=k_{A}×V_{dd}/V_{IN1}.

In the present embodiment, since the amplitude voltage of the ramp voltage V_{RAMP1} is fixed, the combined resistance R_{C} only needs to be inversely proportional to the input voltage V_{IN1}. In other words, it is sufficient that R_{C}/k_{B2} is constant. When R_{C1}=m×R_{B11} (m is a positive number), RC/k_{B2}=m×(R_{C1}+R_{C2}) is established. Therefore, R_{C}/k_{B2} is constant and optimized, independent of the input voltage V_{IN1} and the output voltage V_{OUT3}. Further, in this case, R_{C2}=m×R_{B12}, R_{C3}=m×R_{B13}, and R_{C4}=m×R_{B14} are also established.

In the first embodiment, an example has been described in which the resistance of the first voltage dividing resistor R_{B1}, which is closest to the application terminal of the input voltage V_{IN1} of the input voltage dividing circuit 222, and the resistance of the fifth voltage dividing resistor R_{B5}, which is closest to the application terminal of the output voltage V_{OUT1} of the output voltage dividing circuit 224, are adjusted. In this case, when the input voltage V_{IN1} and the output voltage V_{OUT1} are relatively large, a complex circuit (e.g., a circuit including a level shifter) may be required to switch the resistances of the first voltage dividing resistor R_{B1} and the fifth voltage dividing resistor R_{B5}.

In contrast, in the resistive voltage divider 52 according to the third embodiment, the resistance of the fourth voltage dividing resistor R_{B14}, which is closest to the ground of the input voltage dividing circuit 222, and the resistance of the eighth voltage dividing resistor R_{B18}, which is closest to the ground of the output voltage dividing circuit 524, are adjusted. Thus, it is possible to adjust the voltage division ratios of the input voltage dividing circuit 222 and the output voltage dividing circuit 524 with a simple configuration, without requiring complex circuitry. This also contributes to reducing an area of a semiconductor chip. The voltage division ratios of the input voltage dividing circuit 222 and the output voltage dividing circuit 524 change nonlinearly with respect to the number of counts.

### Fourth Embodiment

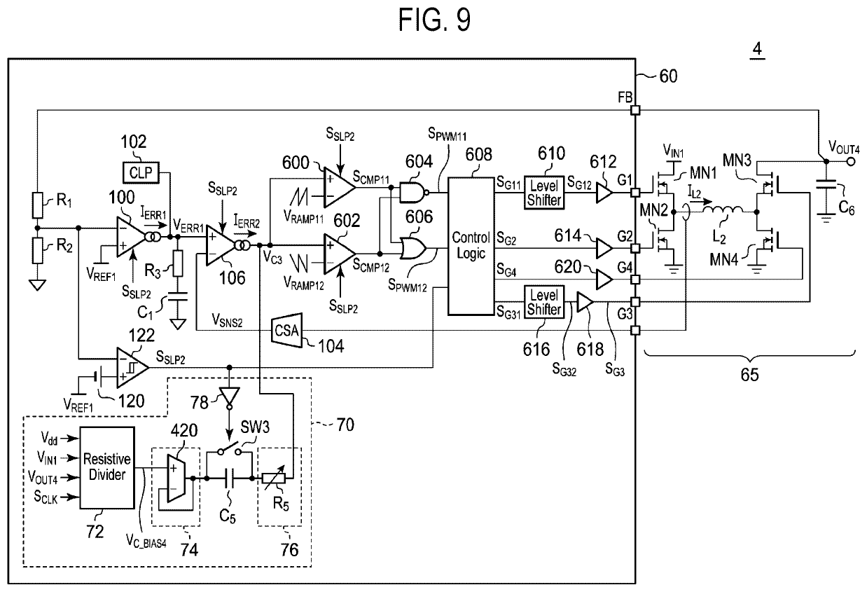

FIG. 9 is a block diagram of a DC/DC converter 4 according to a fourth embodiment. The DC/DC converter 4 according to the present embodiment is of a step-up/down type. The DC/DC converter 4 steps down or steps up the input voltage V_{IN1} to generate an output voltage V_{OUT4}. The DC/DC converter 4 according to the present embodiment includes a controller circuit 60 and a peripheral circuit 65.

The controller circuit 60 includes a voltage supply circuit 70, the first error amplifier 100, the clamp circuit 102, the current sense amplifier 104, the second error amplifier 106, the voltage source 120, the sleep comparator 122, a first PWM comparator 600, a second PWM comparator 602, a NAND gate 604, an OR gate 606, a logic circuit 608, level shifters 610 and 620, buffer circuits 612, 614, 618, and 620, the feedback pin FB, a first gate pin G1, a second gate pin G2, a third gate pin G3, a fourth gate pin G4, the resistors R₁ and R₂, and the capacitor C₁.

The peripheral circuit 65 includes a first transistor MN1, a second transistor MN2, a third transistor MN3, a fourth transistor MN4, an inductor L₂, and a capacitor C₆. In the present embodiment, each of the first transistor MN1, the second transistor MN2, the third transistor MN3, and the fourth transistor MN4 is configured as an N-channel MOS transistor.

A drain of the first transistor MN1 is connected to an application terminal of the input voltage V_{IN1}, and a source of the first transistor MN1 is connected to a drain of the second transistor MN2. A gate of the first transistor MN1 is connected to the first gate pin G1. A source of the second transistor MN2 is grounded, and a gate of the second transistor MN2 is connected to the second gate pin G2.

A drain of the third transistor MN3 is connected to the feedback pin FB, and a source of the third transistor MN3 is connected to a drain of the fourth transistor MN4. A gate of the third transistor MN3 is connected to the third gate pin G3. A source of the fourth transistor MN4 is grounded, and a gate of the fourth transistor MN4 is connected to the fourth gate pin G4.

A first end of the inductor L₂ is connected between the first transistor MN1 and the second transistor MN2, and a second end of the inductor L₂ is connected between the third transistor MN3 and the fourth transistor MN4. A first end of the capacitor C₆ is connected to the feedback pin FB, and a second end of the capacitor C₆ is grounded. The output voltage V_{OUT4} is generated at the first end of the capacitor C₆.

The controller circuit 60 according to the present embodiment is configured to be capable of switching between a sleep mode and a wake-up mode. In the sleep mode, each of the first error amplifier 100, the second error amplifier 106, the first PWM comparator 600, and the second PWM comparator 602 is in a sleep state. Further, in the sleep mode, each of the first transistor MN1, the second transistor MN2, the third transistor MN3, and the fourth transistor MN4 is turned off and stopped. In the wake-up mode, each of the first error amplifier 100, the second error amplifier 106, the first PWM comparator 600, and the second PWM comparator 602 is in an operation state. Further, in the wake-up mode, each of the first transistor MN1, the second transistor MN2, the third transistor MN3, and the fourth transistor MN4 can be switched.

The current sense amplifier 104 according to the present embodiment detects a current I_{L2} flowing through the inductor L₂ to generate a sense voltage V_{SNS2}. The second error amplifier 106 generates a second error current I_{ERR2} corresponding to a difference between the error voltage V_{ERR1} and the sense voltage V_{SNS2}. In the wake-up mode, the second error current I_{ERR2} flows through a resistor R₅ of the voltage supply circuit 70 to be described later, and a comparison voltage V_{C3} is generated. Basically, as the comparison voltage V_{C3} increases, the duty cycle increases, and the controller circuit 60 seamlessly switches from a step-down mode to a step-up mode.

The first PWM comparator 600 compares a periodic first ramp voltage V_{RAMP11} input to a non-inverting input terminal thereof with the comparison voltage V_{C3} input to an inverting input terminal thereof to generate a first comparison signal S_{CMP11}. The second PWM comparator 602 compares a periodic second ramp voltage V_{RAMP12} input to a non-inverting input terminal thereof with the comparison voltage V_{C3} input to an inverting input terminal thereof to generate a second comparison signal S_{CMP12}. The second ramp voltage V_{RAMP12} is a voltage obtained by inverting the first ramp voltage V_{RAMP11}, more specifically, a voltage obtained by inverting the first ramp voltage V_{RAMP11} around a voltage that is half the amplitude voltage of the first ramp voltage V_{RAMP11}.

The NAND gate 604 generates a first PWM signal S_{PWM11} by inverting a logical product of the first comparison signal S_{CMP11} and the second comparison signal S_{CMP12}. The OR gate 606 generates a second PWM signal S_{PWM12} representing a logical sum of the first comparison signal S_{CMP11} and the second comparison signal S_{CMP12}. The logic circuit 608 generates control signals S_{G11} and S_{G31}, a second gate signal S_{G2}, and a fourth gate signal S_{G4} based on the first PWM signal S_{PWM11} and the second PWM signal S_{PWM12}.

The level shifter 610 shifts a level of the control signal S_{G11} to generate a first gate signal S_{G12}. The first gate signal S_{G12} is input to the gate of the first transistor MN1 via the buffer circuit 612 and the first gate pin G1. The second gate signal S_{G2} is input to the gate of the second transistor MN2 via the buffer circuit 614 and the second gate pin G2. The level shifter 616 shifts a level of the control signal S_{G31} to generate a third gate signal S_{G32}. The third gate signal S_{G32} is input to the gate of the third transistor MN3 via the buffer circuit 618 and the third gate pin G3. The fourth gate signal S_{G4} is input to the gate of the fourth transistor MN4 via the buffer circuit 620 and the fourth gate pin G4.

The voltage supply circuit 70 supplies an initial voltage of the comparison voltage V_{C3} to each of the first PWM comparator 600 and the second PWM comparator 602. The voltage supply circuit 70 according to the present embodiment includes a resistive voltage divider 72, a buffer circuit 74, a resistor circuit 76, a NOT gate 78, and a capacitor C₅.

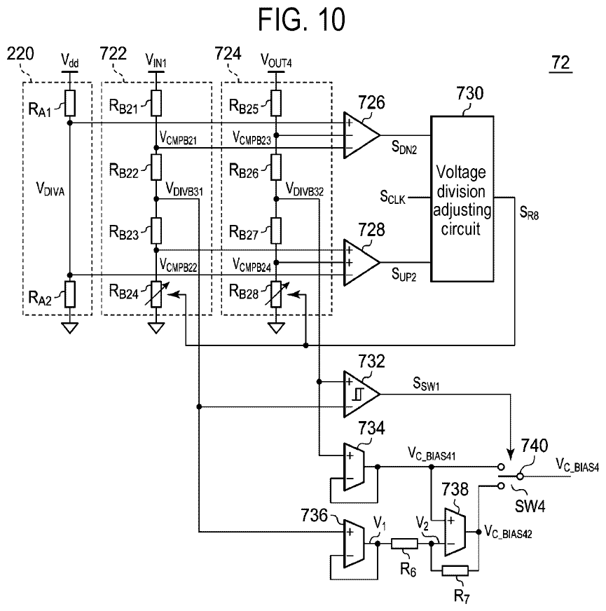

The resistive voltage divider 72 generates a bias voltage V_{C_BIAS4} based on the power supply voltage V_{dd}, the input voltage V_{IN1}, the output voltage V_{OUT4}, and the clock S_{CLK}. In the sleep mode, the bias voltage V_{C_BIAS4} is supplied as the initial voltage of the comparison voltage V_{C3} to each of the first PWM comparator 600 and the second PWM comparator 602 via a switch SW3 and the resistor R₅. A detailed configuration of the resistive voltage divider 72 will be described later with reference to FIG. 10.

The buffer circuit 74, the NOT gate 78, the switch SW3, and the capacitor C₅ may be connected in the same manner as the buffer circuit 42, the NOT gate 56, the switch SW2, and the capacitor C₄ of the voltage supply circuit 50 according to the third embodiment. The resistor circuit 76 according to the present embodiment is configured as a single resistor R₅ and is provided between an end of the capacitor C₅ opposite to the buffer circuit 74 and the output terminal of the second error amplifier 106. The resistor R₅ according to the present embodiment is a variable resistor.

FIG. 10 is a block diagram of the resistive voltage divider 72 according to the fourth embodiment. The resistive voltage divider 72 according to the present embodiment includes the power supply voltage dividing circuit 220, an input voltage dividing circuit 722, an output voltage dividing circuit 724, a first comparator 726, a second comparator 728, a voltage division adjusting circuit 730, a switch comparator 732, a first operational amplifier 734, a second operational amplifier 736, a third operational amplifier 738, a switch SW4, and resistors R₆ and R₇.

The input voltage dividing circuit 722 divides the input voltage V_{IN1} to generate a first comparison voltage V_{CMPB21}, a second comparison voltage V_{CMPB22}, and a first adjustment voltage V_{DIVB31}. Each of the first comparison voltage V_{CMPB21} and the second comparison voltage V_{CMPB22} is an input comparison voltage. The input voltage dividing circuit 722 includes a first voltage dividing resistor R_{B21}, a second voltage dividing resistor R_{B22}, a third voltage dividing resistor R_{B23}, and a fourth voltage dividing resistor R_{B24}, which are connected in series. The first voltage dividing resistor R_{B21}, the second voltage dividing resistor R_{B22}, the third voltage dividing resistor R_{B23}, and the fourth voltage dividing resistor R_{B24} are connected in the same manner as the first voltage dividing resistor R_{B1}, the second voltage dividing resistor R_{B2}, the third voltage dividing resistor R_{B3}, and the fourth voltage dividing resistor R_{B4} according to the first embodiment. The fourth voltage dividing resistor R_{B24} is a variable resistor, and a resistance value thereof is adjusted by a resistance signal S_{R8}.

The output voltage dividing circuit 724 divides the output voltage V_{OUT4} to generate a third comparison voltage V_{CMPB23}, a fourth comparison voltage V_{CMPB24}, and a second adjustment voltage V_{DIVB32}. Each of the third comparison voltage V_{CMPB23} and the fourth comparison voltage V_{CMPB24} is an output comparison voltage. The output voltage dividing circuit 724 includes a fifth voltage dividing resistor R_{B25}, a sixth voltage dividing resistor R_{B26}, a seventh voltage dividing resistor R_{B27}, and an eighth voltage dividing resistor R_{B28}, which are connected in series. The fifth voltage dividing resistor R_{B25}, the sixth voltage dividing resistor R_{B26}, the seventh voltage dividing resistor R_{B27}, and the eighth voltage dividing resistor R_{B28} are connected in the same manner as the fifth voltage dividing resistor R_{B5}, the sixth voltage dividing resistor R_{B6}, the seventh voltage dividing resistor R_{B7}, and the eighth voltage dividing resistor R_{B8} according to the first embodiment.

A resistance value of the fifth voltage dividing resistor R_{B25} is the same as the resistance value of the first voltage dividing resistor R_{B21}, a resistance value of the sixth voltage dividing resistor R_{B26} is the same as the resistance value of the second voltage dividing resistor R_{B22}, and a resistance value of the seventh voltage dividing resistor R_{B27} is the same as the resistance value of the third voltage dividing resistor R_{B23}. The eighth voltage dividing resistor R_{B28} is a variable resistor, and a resistance value thereof is adjusted by the resistance signal S_{R8} so that the resistance value of the eighth voltage dividing resistor R_{B28} becomes the same as the resistance value of the fourth voltage dividing resistor R_{B24}.

The target voltage V_{DIVA} according to the present embodiment has the same magnitude as the common amplitude voltage of the first ramp voltage V_{RAMP11} and the second ramp voltage V_{RAMP12}. The target voltage V_{DIVA} is input to a non-inverting input terminal of the first comparator 726 and the inverting input terminal of the second comparator 728. The first adjustment voltage V_{DIVB31} is generated between the second voltage dividing resistor R_{B22} and the third voltage dividing resistor R_{B23}, and the second adjustment voltage V_{DIVB32} is generated between the sixth voltage dividing resistor R_{B26} and the seventh voltage dividing resistor R_{B27}.

The first comparison voltage V_{CMPB21} is generated between the first voltage dividing resistor R_{B21} and the second voltage dividing resistor R_{B22} and is input to a first inverting input terminal of the first comparator 726. The second comparison voltage V_{CMPB22} is generated between the third voltage dividing resistor R_{B23} and the fourth voltage dividing resistor R_{B24} and is input to a first non-inverting input terminal of the second comparator 728. The third comparison voltage V_{CMPB23} is generated between the fifth voltage dividing resistor R_{B25} and the sixth voltage dividing resistor R_{B26} and is input to a second inverting input terminal of the first comparator 726. The fourth comparison voltage V_{CMPB24} is generated between the seventh voltage dividing resistor R_{B27} and the eighth voltage dividing resistor R_{B28} and is input to a second non-inverting input terminal of the second comparator 728.

The first comparator 726 compares a larger voltage between the first comparison voltage V_{CMPB21} and the third comparison voltage V_{CMPB23} with the target voltage V_{DIVA} to generate a down-signal S_{DN2}. The second comparator 728 compares a larger voltage between the second comparison voltage V_{CMPB22} and the fourth comparison voltage V_{CMPB24} with the target voltage V_{DIVA} to generate an up-signal S_{UP2}.

The voltage division adjusting circuit 730 adjusts voltage division ratios of the input voltage dividing circuit 722 and the output voltage dividing circuit 724.

When the input voltage V_{IN1} is greater than the output voltage V_{OUT4} (i.e., in the step-down mode), the voltage division adjusting circuit 730 according to the present embodiment adjusts the voltage division ratio of the input voltage dividing circuit 722 based on the comparison results of the first comparator 726 and the second comparator 728 so that the first adjustment voltage V_{DIVB31} approaches the amplitude voltage (the target voltage V_{DIVA}). Specifically, the voltage division adjusting circuit 730 can adjust the voltage division ratio of the input voltage dividing circuit 722 based on the down-signal S_{DN2} and the up-signal S_{UP2}, similar to the voltage division adjusting circuit 530 according to the third embodiment.

When the output voltage V_{OUT4} is greater than the input voltage V_{IN1} (i.e., in the step-up mode), the voltage division adjusting circuit 730 adjusts the voltage division ratio of the output voltage dividing circuit 724 based on the comparison results of the first comparator 726 and the second comparator 728 so that the second adjustment voltage V_{DIVB32} approaches the amplitude voltage (the target voltage V_{DIVA}). A method of adjusting the voltage division ratio of the output voltage dividing circuit 724 is the same as a method of adjusting the voltage division ratio of the input voltage dividing circuit 722.

When the input voltage V_{IN1} is greater than the output voltage V_{OUT4}, the voltage division adjusting circuit 730 adjusts the voltage division ratio of the output voltage dividing circuit 724 so that the second adjustment voltage V_{DIVB32} becomes a voltage obtained by dividing the output voltage V_{OUT4} with the voltage division ratio of the adjusted first adjustment voltage V_{DIVB31}. In the present embodiment, the voltage division adjusting circuit 730 adjusts the resistance value of the eighth voltage dividing resistor R_{B28} so that R_{B24}=R_{B28}. Thus, the following equation is satisfied: (R_{B23}+R_{B24})/(R_{B21}+R_{B22}+R_{B23}+R_{B24})=(R_{B27}+R_{B28})/(R_{B25}+R_{B26}+R_{B27}+R_{B28}). In the foregoing equation, the left-hand side is the voltage division ratio of the first adjustment voltage V_{DIVB31}, and the right-hand side is the voltage division ratio of the second adjustment voltage V_{DIVB32}.

When the output voltage V_{OUT4} is greater than the input voltage V_{IN1}, the voltage division adjusting circuit 730 adjusts the voltage division ratio of the input voltage dividing circuit 722 so that the first adjustment voltage V_{DIVB31} becomes a voltage obtained by dividing the input voltage V_{IN1} with the voltage division ratio of the adjusted second adjustment voltage V_{DIVB32}. Specifically, the voltage division adjusting circuit 730 adjusts the resistance value of the fourth voltage dividing resistor R_{B24} so that R_{B24} =R_{B28}.

Each of the first operational amplifier 734 and the second operational amplifier 736 is configured to form a voltage follower. The first operational amplifier 734 buffers the second adjustment voltage V_{DIVB32} and outputs a first bias voltage V_{C_BIAS41} (=V_{DIVB32}). The first bias voltage V_{C_BIAS41} is input to a non-inverting input terminal of the third operational amplifier 738. The second operational amplifier 736 buffers the first adjustment voltage V_{DIVB31} and outputs a first voltage V₁ (=V_{DIVB31}).

The resistor R₆ is provided between an output terminal of the second operational amplifier 736 and an inverting input terminal of the third operational amplifier 738. The resistor R₇ has the same resistance value as the resistor R₆ (R₆=R₇) and is provided between the inverting input terminal of the third operational amplifier 738 and an output terminal of the third operational amplifier 738. The third operational amplifier 738 functions as an inverting amplifier with a gain of −1 and outputs a second bias voltage V_{C_BIAS42}.

In the step-up mode, the second bias voltage V_{C_BIAS42} is a voltage obtained by adding half the amplitude voltage of the ramp voltages (the first ramp voltage V_{RAMP11} and the second ramp voltage V_{RAMP12}) to a differential voltage obtained by subtracting the adjusted second adjustment voltage V_{DIVB32} from the adjusted first adjustment voltage V_{DIVB31}. Specifically, the second bias voltage V_{C_BIAS42} is expressed by the following Equation (2):

$${V}_{C \_ BIAS 42} = {k}_{A} / 2 \times {V}_{d d} + \{ {k}_{A} \times {V}_{d d} \times ( {V}_{OUT 4} - {V}_{IN 1} ) \} / ( 2 \times {V}_{OUT 4} ) .$$

The switch comparator 732 generates a switch signal S_{SW1} based on a magnitude relationship between the input voltage V_{IN1} and the output voltage V_{OUT4}. The switch signal S_{SW1} may be at a high level when the second adjustment voltage V_{DIVB32} is greater than the first adjustment voltage V_{DIVB31}, and at a low level when the first adjustment voltage V_{DIVB31} is greater than the second adjustment voltage V_{DIVB32}.

The switch SW4 connects an output terminal 740 of the resistive voltage divider 72 to one of the output terminals of the first operational amplifier 734 and the third operational amplifier 738. When the switch signal S_{SW1} is at a low level (in the step-down mode), the switch SW4 connects the output terminal 740 to the output terminal of the first operational amplifier 734. As a result, the bias voltage V_{C_BIAS4} output from the output terminal 740 becomes the second adjustment voltage V_{DIVB32}. When the switch signal S_{SW1} is at a high level (in the step-up mode), the switch SW4 connects the output terminal 740 to the output terminal of the third operational amplifier 738. As a result, the bias voltage V_{C_BIAS4} output from the output terminal 740 becomes the second bias voltage V_{C_BIAS42} expressed by Equation (2) described above.

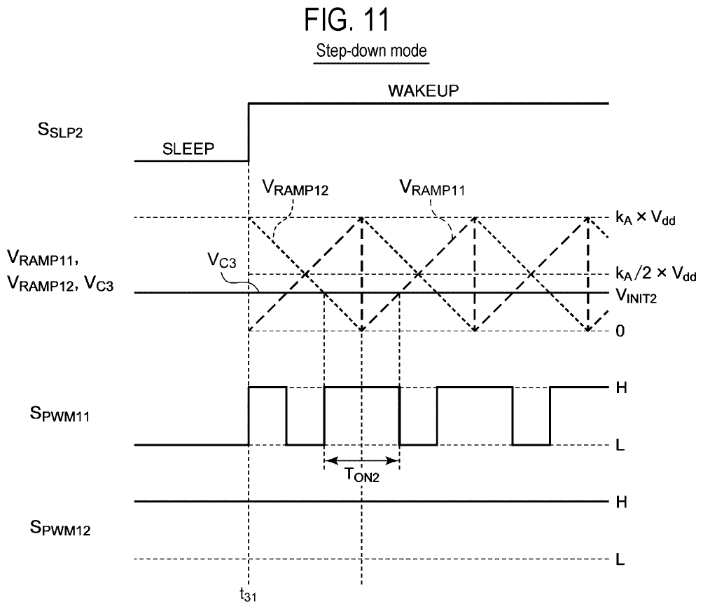

FIG. 11 is a timing chart showing an example of an operation of the DC/DC converter 4 according to the fourth embodiment in the step-down mode. Before timing t₃₁, a sleep signal S_{SLP2} is at a low level, and the controller circuit 60 is in the sleep mode. At this time, the bias voltage V_{C_BIAS4} for an initial voltage V_{INIT2} of the comparison voltage V_{C3} is generated.

At timing t₃₁, the sleep signal S_{SLP2} becomes a high level, and the controller circuit 60 enters the wake-up mode. As a result, the first transistor MN1 and the second transistor MN2 switch with the bias voltage V_{C_BIAS4} set to the initial voltage V_{INIT2} of the comparison voltage V_{C3}.

As shown in FIG. 11, the first ramp voltage V_{RAMP11} rises (ramps up), and the second ramp voltage V_{RAMP12} falls (ramps down). These two ramp voltages intersect at a voltage (k_{A}/2×V_{dd}), which is half the amplitude voltage.

When the comparison voltage V_{C3} is greater than at least one of the two ramp voltages, the first PWM signal S_{PWM11} becomes a high level, the first transistor MN1 is turned on, and the second transistor MN2 is turned off (T_{ON2}). Conversely, when the comparison voltage V_{C3} is smaller than both of the two ramp voltages, the first PWM signal S_{PWM1}1 becomes a low level, the first transistor MN1 is turned off, and the second transistor MN2 is turned on. Further, when the comparison voltage V_{C3} is greater than both of the two ramp voltages, the second PWM signal S_{PWM12} becomes a low level, the fourth transistor MN4 is turned on, and the third transistor MN3 is turned off. Conversely, when the comparison voltage V_{C3} is smaller than at least one of the two ramp voltages, the second PWM signal S_{PWM12} becomes a high level, the fourth transistor MN4 is turned off, and the third transistor MN3 is turned on.

From another point of view, of the two ramp voltages, a triangular wave below k_{A}/2×V_{dd} is a ramp voltage for step-down mode, and a triangular wave above k_{A}/2×V_{dd} is a ramp voltage for step-up mode. Further, when k_{A} is replaced with 2×k_{A}, a ramp amplitude of the lower triangular wave becomes k_{A}×V_{dd}, and thus a relationship between the comparison voltage V_{C3} and the duty cycle is the same as the relationship between the comparison voltage V_{C1} and the duty cycle in the first embodiment.

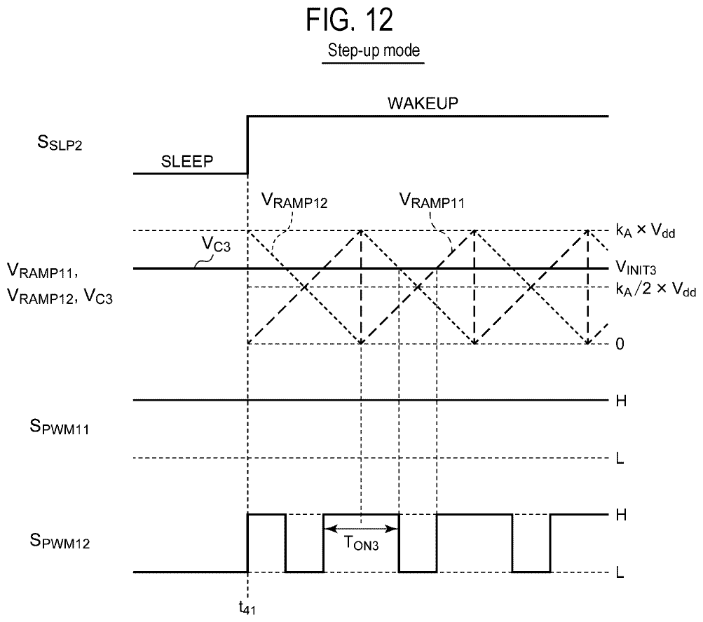

FIG. 12 is a timing chart showing an example of an operation of the DC/DC converter 4 according to the fourth embodiment in the step-up mode. As shown in FIG. 12, at timing t₄₁, the sleep signal S_{SLP2} switches from a low level to a high level, and the third transistor MN3 and the fourth transistor MN4 switch with the bias voltage V_{C_BIAS4} set as an initial voltage V_{INIT3} of the comparison voltage V_{C3}.

An ideal duty cycle in the step-up mode is (V_{OUT4}−V_{IN1})/V_{OUT4}. Therefore, the bias voltage V_{C_BIAS42}, which is expressed by Equation (2) described above, may be set as the initial voltage V_{INIT3} of the comparison voltage V_{C3}.

### Modification 1

In the first embodiment, an example has been described in which the output voltage dividing circuit 224 has the same circuit configuration as the input voltage dividing circuit 222. However, without being limited to this configuration, the output voltage dividing circuit 224 may have any circuit configuration that can achieve the same voltage division ratio as the voltage division ratio of the adjustment voltage V_{DIVB1} in the input voltage dividing circuit 222. For example, the output voltage dividing circuit 224 may have a first resistor having a resistance value of (R_{B1}+R_{B2}) and a second resistor having a resistance value of (R_{B3}+R_{B4}), and may be configured to divide the output voltage V_{OUT1} by these two resistors. This is also applicable to the output voltage dividing circuit 524 according to the third embodiment.

### Modification 2

In the first embodiment, an example has been described in which the switch SW1 is turned on when the PWM comparator 108 is in the sleep state, and the bias voltage V_{C_BIAS1} is supplied as the initial voltage of the comparison voltage V_{C1} via the switch SW1. However, without being limited thereto, in the sleep mode, the operation of the resistive voltage divider 22 may be stopped, the bias voltage V_{C_BIAS1} may be set to a ground voltage (i.e., the output node 225 of the output voltage dividing circuit 224 may be set to a ground voltage), and the switch SW1 may be turned on.

In this case, when the PWM comparator 108 switches from the sleep state to the wake-up state, the switch SW1 is turned off, the resistive voltage divider 22 is activated, and the voltage division ratio of the output voltage dividing circuit 224 is adjusted to generate the bias voltage V_{C_BIAS1}. The bias voltage V_{C_BIAS1} may be supplied as the initial voltage of the comparison voltage V_{C1} via capacitive coupling of the capacitor C₁. As a result, power consumption in the resistive voltage divider 22 during the sleep mode (for example, power consumption caused by an internal bias current) can be suppressed, and it is possible to reduce overall power consumption.

### Modification 3

In the fourth embodiment, an example has been described in which each of the first comparator 726 and the second comparator 728 in the resistive voltage divider 72 compares the comparison voltage of the input voltage dividing circuit 722 with the comparison voltage of the output voltage dividing circuit 724 and selects a comparison voltage to be compared with the target voltage V_{DIVA}. However, without being limited thereto, for example, the switch comparator 732 may compare the input voltage V_{IN1} with the output voltage V_{OUT4} and, based on the comparison result, determine the comparison voltage to be compared by each of the first comparator 726 and the second comparator 728.

For example, when the input voltage V_{IN1} is greater than the output voltage V_{OUT4}, the switch comparator 732 may determine to compare the comparison voltages, which is generated by the input voltage dividing circuit 722, by the first comparator 726 and the second comparator 728, respectively. When the output voltage V_{OUT4} is greater than the input voltage V_{IN1}, the switch comparator 732 may determine to compare the comparison voltages, which is generated by the output voltage dividing circuit 724, by the first comparator 726 and the second comparator 728, respectively. Further, a comparator separate from the switch comparator 732 may be provided for determining the comparison voltages to be compared.

### Supplements

The embodiments according to the present disclosure have been described using specific terms, but this description is merely an example to aid understanding and does not limit the scope of the present disclosure or the claims, and the scope of the present disclosure is defined by the claims. Further, not only the above-described embodiments, but also embodiments, examples, and modifications not described herein are included in the scope of the present disclosure. It is also possible to combine one or more elements of one embodiment with one or more elements of another embodiment.

### SUPPLEMENTARY NOTES

The technique disclosed in the present disclosure can be recognized in one aspect as follows.

### Item 1

A controller circuit of a DC/DC converter that generates an output voltage according to an input voltage, including:
a pulse width modulation (PWM) comparator configured to compare a periodic ramp voltage with a comparison voltage; and
a voltage supply circuit configured to supply an initial voltage of the comparison voltage to the PWM comparator,
wherein the initial voltage is a voltage corresponding to a ratio between the input voltage and the output voltage.

### Item 2

The controller circuit of Item 1, wherein the voltage supply circuit includes:
an input voltage dividing circuit configured to divide the input voltage to generate the comparison voltage and an adjustment voltage;
an output voltage dividing circuit configured to divide the output voltage to generate a bias voltage;
a comparator configured to compare an amplitude voltage of the ramp voltage with the comparison voltage generated by the input voltage dividing circuit; and
a voltage division adjusting circuit configured to adjust a voltage division ratio of each of the input voltage dividing circuit and the output voltage dividing circuit,
wherein the voltage division adjusting circuit adjusts the voltage division ratio of the input voltage dividing circuit based on a comparison result of the comparator so that the adjustment voltage approaches the amplitude voltage, and adjusts the voltage division ratio of the output voltage dividing circuit to generate the bias voltage by dividing the output voltage with a voltage division ratio of the adjustment voltage after the adjustment in the input voltage dividing circuit.

### Item 3

The controller circuit of Item 2, wherein the comparison voltage generated by the input voltage dividing circuit is a first comparison voltage, and the input voltage dividing circuit further generates a second comparison voltage smaller than the first comparison voltage,
wherein the comparator is a first comparator, and the voltage supply circuit further includes a second comparator configured to compare the second comparison voltage with the amplitude voltage, and
wherein the voltage division adjusting circuit adjusts the voltage division ratio of the input voltage dividing circuit based on a first comparison result of the first comparator and a second comparison result of the second comparator so that the amplitude voltage becomes a voltage between the first comparison voltage and the second comparison voltage, and adjusts the voltage division ratio of the output voltage dividing circuit to generate the bias voltage by dividing the output voltage with a voltage division ratio between a voltage division ratio of the first comparison voltage after the adjustment in the input voltage dividing circuit and a voltage division ratio of the second comparison voltage after the adjustment in the input voltage dividing circuit.

### Item 4

The controller circuit of Item 3, wherein the input voltage dividing circuit includes a first voltage dividing resistor, a second voltage dividing resistor, a third voltage dividing resistor, and a fourth voltage dividing resistor, which are connected in series,
wherein one end of the first voltage dividing resistor opposite to the second voltage dividing resistor is connected to an application terminal of the input voltage, and one end of the fourth voltage dividing resistor opposite to the third voltage dividing resistor is connected to a ground,
wherein the first comparison voltage is a voltage between the first voltage dividing resistor and the second voltage dividing resistor, the second comparison voltage is a voltage between the third voltage dividing resistor and the fourth voltage dividing resistor, and the adjustment voltage is a voltage between the second voltage dividing resistor and the third voltage dividing resistor,
wherein at least one of the first voltage dividing resistor or the fourth voltage dividing resistor is a variable resistor, and
wherein the voltage division adjusting circuit adjusts the voltage division ratio of the input voltage dividing circuit by adjusting a resistance value of each of the first voltage dividing resistor and the fourth voltage dividing resistor, and adjusts the voltage division ratio of the output voltage dividing circuit to generate the bias voltage by dividing the output voltage with a voltage division ratio of the adjustment voltage after the adjustment in the input voltage dividing circuit.

### Item 5

The controller circuit of Item 4, wherein the voltage division adjusting circuit sequentially changes the voltage division ratio of the input voltage dividing circuit based on the first comparison result and the second comparison result,
wherein when the first comparison result indicates that the amplitude voltage is greater than the first comparison voltage, the voltage division adjusting circuit increases the first comparison voltage and the second comparison voltage while performing down-counting or up-counting,
wherein when the second comparison result indicates that the second comparison voltage is greater than the amplitude voltage, the voltage division adjusting circuit decreases the first comparison voltage and the second comparison voltage while performing counting opposite to that when the first comparison result indicates that the amplitude voltage is greater than the first comparison voltage, and
wherein the voltage division adjusting circuit adjusts the voltage division ratio of the output voltage dividing circuit based on the counting result.

### Item 6

The controller circuit of any one of Items 3 to 5, wherein the voltage division adjusting circuit completes the adjustment of the voltage division ratio of the input voltage dividing circuit when the first comparison result of the first comparator indicates that the amplitude voltage is smaller than the first comparison voltage and the second comparison result of the second comparator indicates that the second comparison voltage is smaller than the amplitude voltage.

### Item 7

The controller circuit of Item 4 or 5, wherein the fourth voltage dividing resistor is a variable resistor, and
wherein the voltage division adjusting circuit adjusts the voltage division ratio of the input voltage dividing circuit by switching the resistance value of the fourth voltage dividing resistor.

### Item 8

The controller circuit of any one of Items 2 to 7, wherein the voltage supply circuit further includes:
a capacitor provided between an output node of the output voltage dividing circuit and an input terminal of the PWM comparator; and
a switch connected in parallel with the capacitor.

### Item 9

The controller circuit of Item 8, wherein the voltage supply circuit supplies the bias voltage as the initial voltage via the switch when the switch is turned on.

### Item 10

The controller circuit of Item 8, wherein the voltage supply circuit is further configured such that when the PWM comparator is in a sleep state, a voltage at the output node of the output voltage dividing circuit is a ground voltage and the switch is turned on, and when the PWM comparator switches from the sleep state to a wake-up state, the switch is turned off and a bias voltage generated by adjusting the voltage division ratio of the output voltage dividing circuit is supplied as the initial voltage via capacitive coupling of the capacitor.

### Item 11

The controller circuit of any of Items 2 to 10, wherein the voltage supply circuit further includes:
a buffer circuit provided to buffer the bias voltage generated by the output voltage dividing circuit; and
a resistor circuit provided between an output terminal of the buffer circuit and an input terminal of the PWM comparator.

### Item 12

The controller circuit of Item 11, wherein the voltage supply circuit further includes:
a capacitor provided between the output terminal of the buffer circuit and the resistor circuit or between the resistor circuit and the input terminal of the PWM comparator; and
a switch connected in parallel with the capacitor.

### Item 13

The controller circuit of Item 11, wherein the resistor circuit is configured as a variable resistor.

### Item 14

The controller circuit of Item 4 or 5, wherein the voltage supply circuit further includes a buffer circuit provided to buffer the bias voltage generated by the output voltage dividing circuit, and a resistor circuit provided between an output terminal of the buffer circuit and an input terminal of the PWM comparator,
wherein the resistor circuit includes a first resistor path configured as first and second resistors connected in series, and a second resistor path configured as third and fourth resistors connected in series,
wherein the first resistor path is connected in parallel to the second resistor path, and
wherein a ratio between a combined resistance of the first voltage dividing resistor and the second voltage dividing resistor and a combined resistance of the third voltage dividing resistor and the fourth voltage dividing resistor is the same as a ratio between a combined resistance of the first resistor and the second resistor and a combined resistance of the third resistor and the fourth resistor.

### Item 15

The controller circuit of Item 1, wherein the DC/DC converter is of a step-up/down type,
wherein the PWM comparator is a first PWM comparator, and the controller circuit further includes a second PWM comparator,
wherein the first PWM comparator compares the ramp voltage as a first ramp voltage with the comparison voltage,
wherein the second PWM comparator compares a second ramp voltage, which is obtained by inverting the first ramp voltage, with the comparison voltage, which is common to the first PWM comparator, and
wherein the voltage supply circuit supplies the initial voltage of the comparison voltage to each of the first PWM comparator and the second PWM comparator.

### Item 16

The controller circuit of Item 15, wherein the voltage supply circuit includes:
an input voltage dividing circuit configured to divide the input voltage to generate an input comparison voltage and a first adjustment voltage;
an output voltage dividing circuit configured to divide the output voltage to generate an output comparison voltage and a second adjustment voltage;
a comparator; and
a voltage division adjusting circuit configured to adjust a voltage division ratio of each of the input voltage dividing circuit and the output voltage dividing circuit,
wherein the comparator compares the input comparison voltage or the output comparison voltage with a common amplitude voltage of the first ramp voltage and the second ramp voltage, and
wherein the voltage division adjusting circuit is further configured to, based on a comparison result of the comparator:
   when the input voltage is greater than the output voltage, adjust the voltage division ratio of the input voltage dividing circuit so that the first adjustment voltage approaches the amplitude voltage, and adjust the voltage division ratio of the output voltage dividing circuit so that the second adjustment voltage becomes a voltage obtained by dividing the output voltage with a voltage division ratio of the first adjustment voltage after the adjustment in the input voltage dividing circuit; and
   when the output voltage is greater than the input voltage, adjust the voltage division ratio of the output voltage dividing circuit so that the second adjustment voltage approaches the amplitude voltage, and adjust the voltage division ratio of the input voltage dividing circuit so that the first adjustment voltage becomes a voltage obtained by dividing the input voltage with a voltage division ratio of the second adjustment voltage after the adjustment in the output voltage dividing circuit.

### Item 17

The controller circuit of Item 16, wherein the voltage supply circuit is further configured to supply, when the output voltage is greater than the input voltage, a voltage, which is obtained by adding half the amplitude voltage to a differential voltage obtained by subtracting the adjusted second adjustment voltage from the adjusted first adjustment voltage, as the initial voltage.

### Item 18

A DC/DC converter including the controller circuit of any one of Items 1 to 17.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A controller circuit of a DC/DC converter that generates an output voltage according to an input voltage, comprising:
a pulse width modulation (PWM) comparator configured to compare a periodic ramp voltage with a comparison voltage; and
a voltage supply circuit configured to supply an initial voltage of the comparison voltage to the PWM comparator,
wherein the initial voltage is a voltage corresponding to a ratio between the input voltage and the output voltage.

2. The controller circuit of claim 1, wherein the voltage supply circuit includes:
an input voltage dividing circuit configured to divide the input voltage to generate the comparison voltage and an adjustment voltage;
an output voltage dividing circuit configured to divide the output voltage to generate a bias voltage;
a comparator configured to compare an amplitude voltage of the ramp voltage with the comparison voltage generated by the input voltage dividing circuit; and
a voltage division adjusting circuit configured to adjust a voltage division ratio of each of the input voltage dividing circuit and the output voltage dividing circuit,
wherein the voltage division adjusting circuit adjusts the voltage division ratio of the input voltage dividing circuit based on a comparison result of the comparator so that the adjustment voltage approaches the amplitude voltage, and adjusts the voltage division ratio of the output voltage dividing circuit to generate the bias voltage by dividing the output voltage with a voltage division ratio of the adjustment voltage after the adjustment in the input voltage dividing circuit.

3. The controller circuit of claim 2, wherein the comparison voltage generated by the input voltage dividing circuit is a first comparison voltage, and the input voltage dividing circuit further generates a second comparison voltage smaller than the first comparison voltage,
wherein the comparator is a first comparator, and the voltage supply circuit further includes a second comparator configured to compare the second comparison voltage with the amplitude voltage, and
wherein the voltage division adjusting circuit adjusts the voltage division ratio of the input voltage dividing circuit based on a first comparison result of the first comparator and a second comparison result of the second comparator so that the amplitude voltage becomes a voltage between the first comparison voltage and the second comparison voltage, and adjusts the voltage division ratio of the output voltage dividing circuit to generate the bias voltage by dividing the output voltage with a voltage division ratio between a voltage division ratio of the first comparison voltage after the adjustment in the input voltage dividing circuit and a voltage division ratio of the second comparison voltage after the adjustment in the input voltage dividing circuit.

4. The controller circuit of claim 3, wherein the input voltage dividing circuit includes a first voltage dividing resistor, a second voltage dividing resistor, a third voltage dividing resistor, and a fourth voltage dividing resistor, which are connected in series,
wherein one end of the first voltage dividing resistor opposite to the second voltage dividing resistor is connected to an application terminal of the input voltage, and one end of the fourth voltage dividing resistor opposite to the third voltage dividing resistor is connected to a ground,
wherein the first comparison voltage is a voltage between the first voltage dividing resistor and the second voltage dividing resistor, the second comparison voltage is a voltage between the third voltage dividing resistor and the fourth voltage dividing resistor, and the adjustment voltage is a voltage between the second voltage dividing resistor and the third voltage dividing resistor,
wherein at least one of the first voltage dividing resistor or the fourth voltage dividing resistor is a variable resistor, and
wherein the voltage division adjusting circuit adjusts the voltage division ratio of the input voltage dividing circuit by adjusting a resistance value of each of the first voltage dividing resistor and the fourth voltage dividing resistor, and adjusts the voltage division ratio of the output voltage dividing circuit to generate the bias voltage by dividing the output voltage with a voltage division ratio of the adjustment voltage after the adjustment in the input voltage dividing circuit.

5. The controller circuit of claim 4, wherein the voltage division adjusting circuit sequentially changes the voltage division ratio of the input voltage dividing circuit based on the first comparison result and the second comparison result,
wherein when the first comparison result indicates that the amplitude voltage is greater than the first comparison voltage, the voltage division adjusting circuit increases the first comparison voltage and the second comparison voltage while performing down-counting or up-counting,
wherein when the second comparison result indicates that the second comparison voltage is greater than the amplitude voltage, the voltage division adjusting circuit decreases the first comparison voltage and the second comparison voltage while performing counting opposite to that when the first comparison result indicates that the amplitude voltage is greater than the first comparison voltage, and
wherein the voltage division adjusting circuit adjusts the voltage division ratio of the output voltage dividing circuit based on the counting result.

6. The controller circuit of claim 3, wherein the voltage division adjusting circuit completes the adjustment of the voltage division ratio of the input voltage dividing circuit when the first comparison result of the first comparator indicates that the amplitude voltage is smaller than the first comparison voltage and the second comparison result of the second comparator indicates that the second comparison voltage is smaller than the amplitude voltage.

7. The controller circuit of claim 4, wherein the fourth voltage dividing resistor is a variable resistor, and
wherein the voltage division adjusting circuit adjusts the voltage division ratio of the input voltage dividing circuit by switching the resistance value of the fourth voltage dividing resistor.

8. The controller circuit of claim 2, wherein the voltage supply circuit further includes:
a capacitor provided between an output node of the output voltage dividing circuit and an input terminal of the PWM comparator; and
a switch connected in parallel with the capacitor.

9. The controller circuit of claim 8, wherein the voltage supply circuit supplies the bias voltage as the initial voltage via the switch when the switch is turned on.

10. The controller circuit of claim 8, wherein the voltage supply circuit is further configured such that when the PWM comparator is in a sleep state, a voltage at the output node of the output voltage dividing circuit is a ground voltage and the switch is turned on, and when the PWM comparator switches from the sleep state to a wake-up state, the switch is turned off and a bias voltage generated by adjusting the voltage division ratio of the output voltage dividing circuit is supplied as the initial voltage via capacitive coupling of the capacitor.

11. The controller circuit of claim 2, wherein the voltage supply circuit further includes:
a buffer circuit provided to buffer the bias voltage generated by the output voltage dividing circuit; and
a resistor circuit provided between an output terminal of the buffer circuit and an input terminal of the PWM comparator.

12. The controller circuit of claim 11, wherein the voltage supply circuit further includes:
a capacitor provided between the output terminal of the buffer circuit and the resistor circuit or between the resistor circuit and the input terminal of the PWM comparator; and
a switch connected in parallel with the capacitor.

13. The controller circuit of claim 11, wherein the resistor circuit is configured as a variable resistor.

14. The controller circuit of claim 4, wherein the voltage supply circuit further includes a buffer circuit provided to buffer the bias voltage generated by the output voltage dividing circuit, and a resistor circuit provided between an output terminal of the buffer circuit and an input terminal of the PWM comparator,
wherein the resistor circuit includes a first resistor path configured as first and second resistors connected in series, and a second resistor path configured as third and fourth resistors connected in series,
wherein the first resistor path is connected in parallel to the second resistor path, and
wherein a ratio between a combined resistance of the first voltage dividing resistor and the second voltage dividing resistor and a combined resistance of the third voltage dividing resistor and the fourth voltage dividing resistor is the same as a ratio between a combined resistance of the first resistor and the second resistor and a combined resistance of the third resistor and the fourth resistor.

15. The controller circuit of claim 1, wherein the DC/DC converter is of a step-up/down type,
wherein the PWM comparator is a first PWM comparator, and the controller circuit further comprises a second PWM comparator,
wherein the first PWM comparator compares the ramp voltage as a first ramp voltage with the comparison voltage,
wherein the second PWM comparator compares a second ramp voltage, which is obtained by inverting the first ramp voltage, with the comparison voltage, which is common to the first PWM comparator, and
wherein the voltage supply circuit supplies the initial voltage of the comparison voltage to each of the first PWM comparator and the second PWM comparator.

16. The controller circuit of claim 15, wherein the voltage supply circuit includes:
an input voltage dividing circuit configured to divide the input voltage to generate an input comparison voltage and a first adjustment voltage;
an output voltage dividing circuit configured to divide the output voltage to generate an output comparison voltage and a second adjustment voltage;
a comparator; and
a voltage division adjusting circuit configured to adjust a voltage division ratio of each of the input voltage dividing circuit and the output voltage dividing circuit,
wherein the comparator compares the input comparison voltage or the output comparison voltage with a common amplitude voltage of the first ramp voltage and the second ramp voltage, and
wherein the voltage division adjusting circuit is further configured to, based on a comparison result of the comparator:
when the input voltage is greater than the output voltage, adjust the voltage division ratio of the input voltage dividing circuit so that the first adjustment voltage approaches the amplitude voltage, and adjust the voltage division ratio of the output voltage dividing circuit so that the second adjustment voltage becomes a voltage obtained by dividing the output voltage with a voltage division ratio of the first adjustment voltage after the adjustment in the input voltage dividing circuit; and
when the output voltage is greater than the input voltage, adjust the voltage division ratio of the output voltage dividing circuit so that the second adjustment voltage approaches the amplitude voltage, and adjust the voltage division ratio of the input voltage dividing circuit so that the first adjustment voltage becomes a voltage obtained by dividing the input voltage with a voltage division ratio of the second adjustment voltage after the adjustment in the output voltage dividing circuit.

17. The controller circuit of claim 16, wherein the voltage supply circuit is further configured to supply, when the output voltage is greater than the input voltage, a voltage, which is obtained by adding half the amplitude voltage to a differential voltage obtained by subtracting the adjusted second adjustment voltage from the adjusted first adjustment voltage, as the initial voltage.

18. A DC/DC converter comprising the controller circuit of claim 1.
